(19) United States
(12) Patent Application Publication
(10) Pub. No.: US 2026/0202899 A1
(43) Pub. Date: Jul. 16, 2026

(54) SYSTEM AND METHOD FOR CONTROLLING POWER SUPPLY

(71) Applicant: Aivres Systems Inc., Fremont, CA (US)

(72) Inventor: Yen Cheng LU, New Taipei City (TW)

(73) Assignee: Aivres Systems Inc., Fremont, CA (US)

(21) Appl. No.: 19/561,893

(22) Filed: Mar. 10, 2026

(51) Int. Cl. G06F 1/3246

(52) U.S. Cl. CPC G06F 1/3246

(57) ABSTRACT

Systems and methods for controlling power supply of a computing system (e.g., server) are provided. The disclosed system may include one or more processors. The one or more processor may include a first group of processors coupled to a first circuit board, and a second group of processors coupled to a second circuit board. The disclosed system may further include: a controller, a first programmable logic device coupled to the first circuit board, a first power supply coupled to the second circuit board, a second power supply coupled to the second circuit board, and a second programmable logic device coupled to the second circuit board. The second programmable logic device may be configured to control the first power supply that is coupled to the second circuit board. The controller may be configured to control the second power supply that is coupled to the second circuit board.

### TECHNICAL FIELD

The present disclosure relates generally to computing systems, and more particularly, to controlling power supply of the computing systems.

### BACKGROUND

A server device or other computing system often includes a housing (e.g., a chassis) that defines a slot for receiving a motherboard and/or other components. A processor operable to execute instructions to perform computational tasks is often coupled to the motherboard. As the demand for computing systems with superior computing capabilities increases, there is a need to increase the total number of processors within a computing system. Such need often requires the housing of the computing system to include multiple motherboards, where the overall power consumption of the multiple motherboards can be high.

### SUMMARY

Techniques are described herein for reducing power consumption and enhancing computational efficiency of a computing system (e.g., a server device having one or more circuit boards each hosting one or more processors).

According to one aspect of the present disclosure, a system is provided. The system may include: one or more processors. The one or more processors may include: a first group of processors coupled to a first circuit board, and a second group of processors coupled to a second circuit board. The system may further include: a controller, a first programmable logic device coupled to the first circuit board, a first power supply coupled to the second circuit board, a second power supply coupled to the second circuit board, and/or a second programmable logic device coupled to the second circuit board. The second programmable logic device may be configured to control the first power supply that is coupled to the second circuit board. The controller may be configured to control the second power supply that is coupled to the second circuit board.

In some embodiments, the first power supply may be configured to at least supply power to the second group of processors that is coupled to the second circuit board. In this case, the second programmable logic device may be configured to control the first power supply, thereby powering on (or powering off) the second group of processors. Additionally, or alternatively, the second power supply may be configured to at least supply power to the second programmable logic device that is coupled to the second circuit board. In this case, the controller may be configured to control the second power supply, thereby powering on (or powering off) the second programmable logic device.

In some embodiments, the first power supply may be further configured to supply power to one or more cooling units (e.g., fans, liquid cooling units) coupled to the second circuit board. Additionally, or alternatively, the second power supply may be configured to supply power to one or more memory devices (or memory cards) coupled to the second circuit board.

In some embodiments, the controller may be coupled to the first programmable logic device, to control the first programmable logic device, and the first programmable logic device may be further coupled to the second programmable logic device, to control the second programmable logic device.

In some embodiments, the controller may be further coupled to the second programmable logic device, and the controller may be configured to control the second programmable logic device, e.g., in response to detecting that the first programmable logic device is in an abnormal condition.

In some embodiments, the controller may be configured to monitor at least one processor from the one or more processors, to determine whether any triggering event is detected.

In some embodiments, the system may include one or more memories associated with the one or more processors. In some embodiments, the controller may be configured to determine that a first triggering event is detected based on: detecting that at least one utilization rate associated with the one or more processors is below a first processor utilization rate threshold for a first time period, or detecting that at least one utilization rate associated with the one or more memories is below a first memory utilization rate threshold for a second time period.

In some embodiments, the at least one utilization rate associated with the one or more processors include: an overall utilization rate of the one or more processors, a utilization rate of the first processor, or a utilization rate of the second processor. For example, the at least one utilization rate associated with the one or more processors may include the overall utilization rate of the one or more processors. As another example, the at least one utilization rate associated with the one or more processors may include a utilization rate of each of the one or more processors (including the first and second groups of processors). As a further example, the at least one utilization rate associated with the one or more processors may include a utilization rate of a single processor from the one or more processors. As a yet further example, the at least one utilization rate associated with the one or more processor may include a utilization rate of each processor from a subset of the one or more processors.

In some embodiments, in response to determining that the first triggering event is detected, the controller may be configured to: transmit a first message to power off the second circuit board, to the first programmable logic device. In some embodiments, transmitting the first message to the first programmable logic device causes the first programmable logic device to transmit a first command that powers off the first power supply, to the second programmable logic device. In some embodiments, transmitting the first command to the second programmable logic device causes the second programmable logic device to turn off the first power supply that is coupled to the second circuit board.

In some embodiments, the controller is further configured to: receive a first notification indicating that the first power supply has been turned off; and in response to receiving the first notification indicating that the first power supply has been turned off, control the second power supply to be turned off. The first notification may be received directly from the second programmable logic device. Additionally, or alternatively, the first notification may be received indirectly from the second programmable logic device via the first programmable logic device.

In some embodiments, prior to transmitting the first message to power off the second circuit board to the first programmable logic device, an operating system may be configured to allocate one or more tasks executable using the second group of processors to one or more additional processors that are not from the second group of processors.

In some embodiments, the controller is configured to determine that a second triggering event is detected based on: detecting that one or more utilization rates associated with the one or more processors is beyond a second processor utilization rate threshold for a first duration, or detecting that one or more utilization rates associated with the one or more memories is beyond a second memory utilization rate threshold for a second duration.

In some embodiments, in response to determining that the second triggering event is detected, the controller is configured to: control the second power supply, to turn on the second power supply, and transmit a second message to power on the second circuit board to the first programmable logic device. In some embodiments, transmitting the second message to the first programmable logic device causes the first programmable logic device to transmit a second command that powers on the first power supply, to the second programmable logic device. In some embodiments, transmitting the second command to the second programmable logic device causes the second programmable logic device to turn on the first power supply.

In some embodiments, the controller is configured to: determine that a third triggering event is detected based on: detecting that the first or second programmable logic device of the system is abnormal; and in response to determining that the third triggering event is detected, turn off or restart a standby power supply that supplies power to the first or second programmable logic device that is detected to be abnormal.

In some embodiments, the controller is further configured to: control the second programmable logic device to turn on or off the first power supply, in response to detecting that the first programmable logic device is in an abnormal condition.

In some embodiments, the controller is coupled, or in proximity, to the first circuit board.

In some embodiments, the system further include: a first main power supply coupled to the first circuit board; and a first standby power supply coupled to the first circuit board. The first main power supply may be controlled using the first programmable logic device, and the first standby power supply may be controlled using the controller.

In some embodiments, the one or more processors may further include: a third group of processors coupled to a third circuit board. The third circuit board may be distinct from the first circuit board and/or may be distinct from the second circuit board. In some embodiments, the system may further include: a third programmable logic device coupled to the third circuit board. The first programmable logic device may be further coupled to the third programmable logic device, to control the third programmable logic device.

According to another aspect of the present disclosure, a method is provided for controlling power supply of a computing system. The computing system may include one or more memories, one or more processors, a first programmable logic device coupled to the first circuit board, a second programmable logic device coupled to the second circuit board, and a first power supply and a second power supply that are coupled to the second circuit board. The method may include: detecting a first triggering event to power off the second circuit board, where detecting the first triggering event may include: detecting that a utilization rate of the one or more processors is below a first processor utilization rate threshold for a first time period, or detecting that a utilization rate of the one or more memories is below a first memory utilization rate threshold for a second time period. In response to detecting the first triggering event, the method may further include: transmitting a first message to power off the second circuit board to the first programmable logic device that is coupled to the first circuit board, where transmitting the first message to power off the second circuit board to the first programmable logic device causes the first programmable logic device to transmit a first command that powers off the first power supply, to the second programmable logic device that is coupled to the second circuit board, and where transmitting the first command to the second programmable logic device causes the second programmable logic device to turn off the first power supply that is coupled to the second circuit board.

In some embodiments, the method may further include: receiving a first notification notifying that the first power supply has been turned off; and in response to receiving the first notification notifying that the first power supply has been turned off, controlling the second power supply to be turned off.

In some embodiments, the method may further include: monitoring the first programmable logic device and the second programmable logic device; and in response to detecting that the first or second programmable logic device is abnormal, restarting or turning off a power supply that supplies power to the first programmable logic device, or the second programmable logic device, that is detected to be abnormal.

According to another aspect of the present disclosure, another method for controlling power supply of a computing system is provided. The computing system may include: one or more memories, one or more processors, a first programmable logic device coupled to the first circuit board, a second programmable logic device coupled to the second circuit board, and a first power supply and a second power supply that are coupled to the second circuit board. The method may include: detecting a second triggering event to power on the second circuit board. The detecting the second triggering event may include: detecting that a utilization rate of the one or more processors is beyond a second processor utilization rate threshold for a first duration, or detecting that a utilization rate of the one or more memories is beyond a second memory utilization rate threshold for a second duration. In response to detecting the second triggering event, the method may further include: controlling the second power supply to turn on the second power supply that is coupled to the second circuit board; transmitting a message that powers on the second circuit board, to the first programmable logic device, where transmitting the message that powers on the second circuit board to the first programmable logic device causes the first programmable logic device to transmit a command that powers on the first power supply, to the second programmable logic device that is coupled to the second circuit board, and where transmitting the command to the second programmable logic device causes the second programmable logic device to turn on the first power supply that is coupled to the second circuit board.

### BRIEF DESCRIPTION OF THE DRAWINGS

Systems and methods of the present disclosure are described in detail below with reference to the attached drawing figures, wherein:

FIG. 1 illustrates a block diagram of an example system, according to one or more embodiments of the present disclosure.

FIG. 2 illustrates a perspective view of an example server device, according to one or more embodiments of the present disclosure.

FIG. 3A illustrates a block diagram showing an example computing system having multiple computing nodes, according to one or more embodiments of the present disclosure.

FIG. 3B illustrates a flow chart showing a process where a logic device in FIG. 3A detected to be abnormal is powered off or reset, according to one or more embodiments of the present disclosure.

FIG. 3C illustrates a flow chart showing a process where at least one of the multiple computing nodes in FIG. 3A is powered off, according to one or more embodiments of the present disclosure.

FIG. 3D illustrates a flow chart showing a process where at least one of the multiple computing nodes in FIG. 3A is powered on, according to one or more embodiments of the present disclosure.

FIG. 4 illustrates a block diagram showing another example computing system having multiple computing nodes, according to one or more embodiments of the present disclosure.

FIG. 5A and FIG. 5B illustrate a method for controlling a power supply of a computing system, according to one or more embodiments of the present disclosure.

FIG. 5C illustrates another method for controlling power supply of a computing system, according to one or more embodiments of the present disclosure.

FIG. 6A, FIG. 6B, and FIG. 6C illustrate yet another method for controlling power supplies of a computing system, according to one or more embodiments of the present disclosure.

### DETAILED DESCRIPTION

The following detailed description is exemplary in nature and is not intended to limit the disclosure or the application and uses of the described embodiments. Furthermore, there is no intention to be bound by any expressed or implied theory presented in the preceding background, summary and brief description of the drawings, or the following detailed description. Numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

The similar reference numerals may refer to the same or similar functions in various aspects. In the drawings, the shapes and dimensions of elements may be exaggerated for clarity. A variety of modifications may be made to the present disclosure, and various embodiments are provided with reference to drawings and described in detail. It should be understood that the various embodiments of the present disclosure, although different, are not necessarily mutually exclusive. For example, specific features, structures, locations, and other characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure.

Terms such as “first,” “second,” etc. may be used to describe various components, but the components are not to be construed as being limited to the terms. The terms are only used to differentiate one component from other components. In some embodiments, the “first” component may be named the “second” component without departing from the scope of the present disclosure, and the “second” component may also be similarly named the “first” component. In some embodiments, the “first” component may be distinct from the “second” component, and the “first” component may encompass more than one element and succeed (or precede) the “second” component in an ordering of components. The term “and/or” may be used to include a combination of a plurality of items or any one (or a subset) of the plurality of terms.

It will be understood that when an element (or component) is simply referred to as being “connected to” or “coupled to” another element (or component) without being “directly connected to” or “directly coupled to” another element in the present disclosure, it may be “directly connected to” or “directly coupled to” another element or be indirectly connected to or coupled to another element, having the other element intervening therebetween. In contrast, it should be understood that when an element is referred to as being “directly coupled” or “directly connected” to another element, there are no intervening element(s) present. As used herein, the term “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

A server device (e.g., rack server) or other computing system may include a housing (e.g., a chassis) that defines a slot for receiving one or more motherboards and/or other components (e.g., a drive-plane board having one or more storage-drive connectors each detachably mated with a storage drive). Each of the one or more motherboards can include, or be coupled with, one or more processors (e.g., a central processing unit, “CPU”) that are operable to execute instructions, in order to perform one or more tasks. As the total number of processors included in the server device (or other computing system) is increased to satisfy the demand for high-end computing systems, the housing of a computing system often includes more motherboards (or other applicable circuit board) to which processor(s) are coupled. The power consumption of multiple motherboards included in the computing system can become unnecessarily high for the computing system.

Systems and methods are disclosed herein that relate to controlling power supply of a computing system in a flexible, automatic, and efficient manner. The computing system can be, or can include, a server device (or any other applicable device). In some embodiments, the computing system can include one or more nodes, where each of the one or more nodes is a physical computing node that includes one or more processors (and/or other components such as memory and I/O adapters). The one or more processors of each physical computing node may be correspondingly coupled to a motherboard (or other applicable circuit board). As a working example, a housing (e.g., chassis) of the computing system (e.g., server device) may be configured to host a first computing node and a second computing node, where the first computing node includes a first processor that is coupled to a first motherboard and the second computing node includes a second processor that is coupled to a second motherboard.

Continuing with the working example above, the first computing node may further, or alternatively, include a first logic device and a first set of power supplies, and the second computing node may further, or alternatively, include a second logic device and a second set of power supplies. In certain embodiments, the first or second logic device may be a programmable logic device, such as a complex programmable logic device (CPLD) or any other applicable logic device. The first set of power supplies can include a first main power supply and/or a first standby power supply. The first logic device (e.g., first CPLD that is coupled to the first motherboard) may be coupled to the first main power supply, to control (e.g., power on, power off, etc.) the first main power supply. The second set of power supplies can include a second main power supply and/or a second standby power supply. Correspondingly, the second logic device (e.g., a second CPLD that is coupled to the second motherboard) may be coupled to the second main power supply, to control (e.g., power on, power off, etc.) the second main power supply.

In the working example above, the first main power supply may be a first main power supply circuit (or a first main power supply chip) configured to supply power at (and/or above) a first voltage level (e.g., 12V and/or 48V, etc.). The first main power supply may be configured to supply power to a first set of components (e.g., the first processor, cooling unit(s) coupled to the first motherboard, etc.) of the first computing node. In this case, powering off (or on) the first main power supply, e.g., using the first CPLD, may cause the first processor to be de-activated (or activated). Additionally, or alternatively, the second main power supply may be a second main power supply circuit (or a second main power supply chip) configured to supply power at (and/or above) a second voltage level (e.g., 12V and/or 48V, etc.). The second main power supply may be configured to supply power to a first set of components (e.g., the second processor, cooling unit(s) coupled to the second motherboard, etc.) of the second computing node. In this case, powering off (or on) the second main power supply, e.g., using the second CPLD, may cause the second processor to be de-activated (or activated).

In some embodiments, the second voltage level may be the same as, or different from, the first voltage level. For example, the first and second voltage levels may be both 12V, or may be both 48V. As another example, the first voltage level may be 12V, and the second voltage level may be 48V, or vice versa.

Continuing with the working example above, the first standby power supply may be a first standby power supply circuit (or a first standby power supply chip) configured to supply power at (and/or below) a third voltage level (e.g., 12V, 5V, 3.3V, and/or 1.8V, etc.). The first standby power supply may be configured to supply power to a second set of components (e.g., first CPLD, first memory coupled to the first motherboard) of the first computing node. As a result, powering off (or on) the first standby power supply may cause the first CPLD (and/or first memory) to stop (or start) operation. Accordingly, powering off the first standby power supply may cause the first main power supply (which may be controlled using the first CPLD) to be turned off, which de-activates the first processor.

Additionally, or alternatively, the second standby power supply may be a second standby power supply circuit (or a second standby power supply chip) configured to supply power at (and/or below) a fourth voltage level (e.g., 12V, 5V, 3.3V, and/or 1.8V, etc.). The second standby power supply may be configured to supply power to a second set of components (e.g., second CPLD, second memory coupled to the second motherboard) of the second computing node. As a result, powering off (or on) the second standby power supply may at least cause the second CPLD (and/or second memory) to stop (or start) operation. Accordingly, powering off the second standby power supply may cause the second main power supply (which may be controlled using the second CPLD) to be turned off.

In some embodiments, the third voltage level may be the same as, or different from, the fourth voltage level. For example, the third and fourth voltage levels may be both 12V, or may be both 5V. As another example, the third voltage level may be 12V, and the fourth voltage level may be 5V, or vice versa. It is noted that, the first voltage level may be greater than, or equal to, the third voltage level, and the second voltage level may be greater than or equal to the fourth voltage level. However, the present disclosure is not intended to be limiting.

In some embodiment, the first standby power supply may be configured to supply power to all components of the first computing node except for the first processor (and/or one or more additional components requiring power supply at or above the first voltage level). In this case, powering off the first standby power supply may cause the first motherboard (or the first computing node) to be powered off. This is because, in the disclosed systems and methods, powering off the first standby power supply causes the first CPLD, along with various other components of the first computing node (excluding the first processor), to lose access to power supply. As a result, the first main power supply (which supplies power to the first processor based on operation(s) of the first CPLD) is turned off, in response to the first standby power supply being turned/powered off. The first motherboard (or the first computing node) is therefore turned off when both the first main power supply and the first standby power supply are turned off.

It is noted that, powering on the first standby power supply does not necessarily power on all components coupled to the first motherboard. For example, while powering on the first standby power supply may cause the first CPLD to start operation, powering on the first standby power supply does not guarantee that the first processor is activated for operation, since the first CPLD operates to turn on (or off) the first main power supply that supplies power to the first processor.

In some embodiments, additionally, or alternatively, the second standby power supply may be configured to supply power to all components of the second computing node except for the second processor (and/or one or more additional components requiring power supply at or above the second voltage level). In this case, powering off the second standby power supply may cause the second motherboard (or the second computing node) to be powered off. For similar reasons stated above, powering on the second standby power supply does not necessarily power on all components coupled to the second motherboard.

Continuing with the working example above, the computing system (e.g., server device) may further include a controller, e.g., a baseboard management controller (BMC). The aforementioned first standby power supply, first CPLD, and/or first processor, that are coupled to (e.g., installed on) the first motherboard, may be coupled to (e.g., electrically connected to) the controller (e.g., BMC) that manages and monitors the computing system. Additionally, or alternatively, the second standby power supply, the second CPLD, and/or the second processor, that are coupled to (e.g., installed on) the second motherboard, may be coupled to (e.g., electrically connected to) the controller (e.g., BMC).

In some embodiments, in addition to controlling the first main power supply on the first motherboard, the first CPLD may be coupled to the second CPLD (e.g., via a first link) to control the second CPLD. The second CPLD may be configured to control the second main power supply on the second motherboard, and be in communication with the first CPLD. In this case, the first CPLD may be configured to control the second CPLD, to turn on (or turn off) the second main power supply (which may supply power to the second processor that is coupled to the second motherboard). Additionally, or alternatively, the controller (e.g., BMC) may be configured to control the first CPLD (e.g., via a second link), thereby controlling the second CPLD to turn on (or off) the second main power supply on the second motherboard. Additionally, or alternatively, the controller (e.g., BMC) may be configured to control the second CPLD, e.g., directly and based on a third link, to turn on (or off) the second main power supply on the second motherboard. In some embodiments, the first and second links may be a high-speed communication link, respectively, and the third link may be a low-speed communication link. In this case, the controller (e.g., BMC) may be configured to control the second CPLD directly (e.g., based on a third link) to turn on (or off) the second main power supply, in response to detecting that the first link, the second link, or the first CPLD is abnormal.

In some embodiments, the controller (e.g., BMC) may be configured to monitor utilization rate of all processors and memories of the computing system. For example, based on communication with the first processor (or the second processor), the controller (e.g., BMC) may acquire a utilization rate of the first processor, a utilization rate of the second processor, utilization rate(s) of other applicable processor(s), and/or a total utilization rate of all processors of the computing system. This may be facilitated by the first processor being in communication with the second processor and other applicable processor(s), via a communication interface such as GMII (Gigabit Media Independent Interface) or Intel® Ultra Path Interconnect (UPI).

In some embodiments, the first processor (or a different processor) may determine the total utilization rate of all processors of the computing system, and BMC may acquire the total utilization rate of all processors from the first processor (or a different processor). In some other embodiments, the controller may determine the total utilization rate of all processors of the computing system, e.g., based on a utilization rate of each processor acquired from the first processor (or other processor(s)).

Additionally, or alternatively, based on communication with the first processor (or the second processor), the controller (e.g., BMC) may acquire a utilization rate of first memory coupled to the first motherboard, a utilization rate of second memory coupled to the second motherboard, utilization rate of other memories (if applicable), and/or a total utilization rate of all memories associated with the computing system. This may be facilitated by the first processor being in communication with the first memory, second memory, and other applicable memories.

In some embodiments, the controller (e.g., BMC) may be configured to detect a first triggering event that triggers power-off of the second computing node (or the second motherboard). For example, continuing with the working example above, the controller (e.g., BMC) may detect the first triggering event by detecting that the total utilization rate of processors associated with the computing system (e.g., a rack server) is below a first processor utilization rate (e.g., approximately 20%) for a first time period (e.g., approximately 5 min), and/or by detecting that the total utilization rate of memories associated with the computing system (e.g., rack server) is below a first memory utilization rate (e.g., approximately 30%) for a second time period (approximately 5 min). As another example, the controller (e.g., BMC) may detect the first triggering event by detecting that the first processor (or the first computing node) is being utilized and that the utilization rate of the first processor is below the first processor utilization rate threshold (e.g., 20%) for the first time period (e.g., 5 min), and/or detecting that the utilization rate of first memory is below the first memory utilization rate threshold (e.g., 30%) for the second time period (e.g., 5 min).

As a further example, the controller (e.g., BMC) may detect the first triggering event by detecting that the utilization rate of each of one or more processors (e.g., first and second processors) of the computing system is below the first processor utilization rate threshold (e.g., 20%) for the first time period (e.g., 5 min), and/or detecting that the utilization rate of each of one or more memories (e.g., the first and second memories) of the computing system is below the first memory utilization rate threshold (e.g., 30%) for the second time period (e.g., 5 min). In this example, the controller may detect the first triggering event in this manner because the disclosed computing system may be configured to allocate same or similar working/computational load to each processor of the computing system.

In some embodiments, in response to detecting the first triggering event, the controller (e.g., BMC) may be configured to generate a first message (e.g., that instructs to power off the second set of power supplies on the second motherboard), and transmit the first message to the first CPLD. In response to receiving the first message from the BMC, the first CPLD may generate a first command to power off the second main power supply on the second motherboard and transmit the first command to the second CPLD. In response to receiving the first command from the first CPLD, the second CPLD may power off the second main power supply on the second motherboard and send a first notification to the BMC notifying that the second motherboard has been powered off.

In some embodiments, in the disclosed system or method, prior to powering off the second main power supply on the second motherboard (which may therefore de-activate the second processor coupled to the second motherboard), tasks allocated to the second processor (or to the second computing node) may be re-allocated to other processors (e.g., the first processor and/or other applicable processor, if any), to prevent interruption of tasks, data lost, etc. It is noted that, powering off the second main power supply on the second motherboard to de-activate the second processor may reduce a large portion of the power consumption of the computing system as the second main power supply may be configured to supply power to the second processor at a high voltage level (e.g., 12V, or 48V, etc.). For example, in some cases, powering off the second main power supply on the second motherboard may cause the second motherboard to enter a “standby” mode where the second processor (to which the second main power supply supplies power) and/or other components (e.g., fans) whose operation require a relatively high voltage level (e.g., 12V, 48V, etc.) are de-activated (or powered off). In a “standby” mode, a circuit board (e.g., the second motherboard) consumes relatively low power, e.g., lower than when the second main power supply is powered on.

In some embodiments, in response to receiving the first notification from the second CPLD, the controller (e.g., BMC) may be further configured to control the second standby power supply on the second motherboard, to power off the second standby power supply. This may power off all components (or a majority thereof) coupled to the second motherboard, which would otherwise not be possible without cutting off the alternating current (AC) from a wall outlet for the computing system. Accordingly, power consumption of the second motherboard is further reduced (e.g., to zero). As a result, the disclosed method and system enable the overall power consumption of the computing system that includes both first and second motherboards to be reduced as much as possible.

Additionally, or alternatively, after the second computing node is turned off (or in other applicable scenarios where the second computing node is powered off), the controller (e.g., BMC) may detect a second triggering event that triggers power-on of the second computing node (or the second motherboard). For instance, continuing with the working example above, the controller (e.g., BMC) may detect the second triggering event by detecting that the total utilization rate of processors (e.g., the first processor and other active processor(s), if any) associated with the computing system (e.g., a rack server) is above (or beyond) a second processor utilization rate (e.g., approximately 80%) for a third time period (e.g., approximately 5 min), and/or by detecting that the total utilization rate of memories associated with the computing system (e.g., rack server) is above a second memory utilization rate (e.g., approximately 90%) for a fourth time period (approximately 5 min).

As another example, the BMC may detect the second triggering event by detecting that the utilization rate of the first processor (or another active processor) is beyond the second processor utilization rate threshold (e.g., 80%) for the third first time period (e.g., 5 min), and/or detecting that the utilization rate of first memory (or another active memory) is above the second memory utilization rate (e.g., approximately 90%) for the fourth time period. In this case, the BMC may be configured to turn on the second standby power supply that is on the second motherboard, e.g., based on an Enable signal transmitted between the BMC and the second standby power supply. In response to determining that the standby power supply has been powered on, the BMC may generate a second message to turn on the second motherboard (or to turn on the second set of power supplies, or to turn on the second computing node, etc.) and transmit the second message to the first CPLD. In response to receiving the second message from the BMC, the first CPLD may generate a second command (e.g., that instructs to turn on the second main power supply on the second motherboard) and transmit the second command to the second CPLD. In response to receiving the second command from the first CPLD, the second CPLD may turn on the second main power supply, such that the second processor is activated and can be applied to execute instructions. Accordingly, the disclosed method and system allow the computational capabilities of the computing system to be increased in case where the BMC detects the second triggering event.

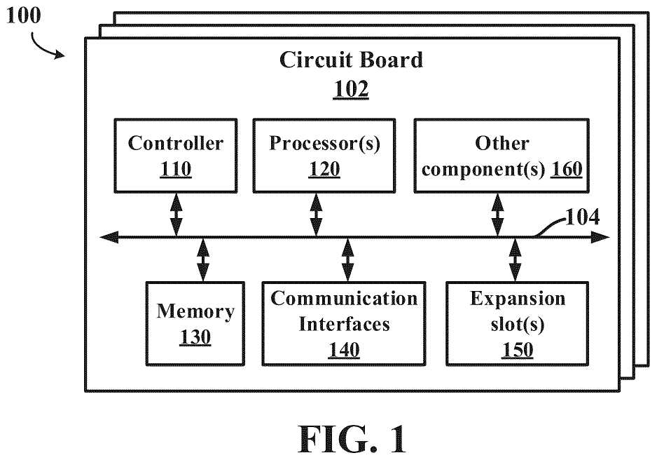

FIG. 1 illustrates a block diagram of a system 100, e.g., server, suitable for use in implementing embodiments of the present disclosure. It should be noted that the arrangements described herein, including this example, are provided for illustrative purposes only. Alternative configurations and components may be used in place of or in addition to those shown, and some components may be omitted entirely. Moreover, many of the elements described are functional in nature and can be implemented as standalone or distributed components or devices, either independently or in combination with other components, and located in various configurations. The functions discussed may be executed through hardware, firmware, and/or software, with processes typically performed by a processor running instructions stored in memory. Additionally, those skilled in the art will recognize that any system capable of performing the operations of the server system 100 falls within the scope and intent of the disclosed embodiments. The server system 100 can be housed in a rack-mounted chassis designed for optimal airflow and cooling, ensuring efficient heat dissipation during operation. Yet further, a person skilled in the art will recognize that the systems and methods described herein can be used with electronic systems and computer systems other than server systems.

The system 100 may include one or more circuit boards (e.g., 102), where a plurality of the one or more circuit boards may be a motherboard and may carry various components, including hardware, firmware, and/or software, which may be integrated with, attached to, connected to, or in communication with the motherboard. As shown in FIG. 1, the circuit board 102 carries at least one controller 110, such as a baseboard management controller (BMC), one or more processors 120, memory 130, communication interfaces 140, one or more expansion slots 150, and one or more other components 160. Such components and the circuit board 102 can communicate with one another through a bus 104, which may be integrated into the circuit board 102. It will be understood that the components of the circuit board 102 are provided by way of example only and may vary depending on the particular application.

Processor(s) 120 may be configured to perform the operations in accordance with the computer readable instructions stored in memory 130. In certain embodiments, the memory 130 may be integral to the processor(s) 120. In other embodiments, the memory may in whole or in part be separate from the processor(s) 120. Processor(s) 120 may include any appropriate type of general-purpose or special-purpose microprocessor or microcontroller (e.g., a central processing unit (CPU) or graphics processing unit (GPU), respectively), digital signal processor, microcontroller, or the like. Memory 130 may be configured to store computer-readable instructions that, when executed by processor(s) 120, can cause processor(s) 120 to perform various operations disclosed herein and/or store data relating thereto.

Memory 130 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), an electrical erasable programmable ROM (EEPROM), a flash memory, a dynamic random-access memory (“RAM”), and/or a static RAM. In certain embodiments, memory 130 may include multiple storage devices of various types.

Communication interfaces 140 may be configured to communicate information between system 100 and other devices or systems. For example, communication interfaces 140 may include an integrated services digital network (“ISDN”) card, a cable modem, a satellite modem, or a modem to provide a data communication connection. As another example, communication interfaces 140 may include a local area network (“LAN”) card to provide a data communication connection to a compatible LAN. As a further example, communication interfaces 140 may include a high-speed network adapter such as a fiber optic network adaptor, 10G Ethernet adaptor, or the like. Wireless links can also be implemented by communication interfaces 140. In such an implementation, communication interfaces 140 can send and receive electrical, electromagnetic, or optical signals that carry digital data streams representing various types of information via a network. The network can typically include a cellular communication network, a Wireless Local Area Network (“WLAN”), a Wide Area Network (“WAN”), or the like.

In certain embodiments, controller 110, e.g., BMC, may include a processing unit, associated memory, and communication interfaces, and is configured to monitor and manage the system's hardware components among other things. Controller 110 handles tasks such as remote system management, including hardware health monitoring, system event logging, and power control. Controller 110 can operate independently of the system's 100 main processor (e.g., processor(s) 120), allowing for out-of-band management. Controller 110 may, in certain embodiments, facilitate communication with various sensors (e.g., other component(s) 160) on the circuit board 102 to track temperature, fan speed, voltage levels, and other critical parameters. Additionally, the controller 110 may include network interfaces and/or operate in conjunction with communication interfaces 140 to enable remote access for system administrators, providing a way to perform diagnostic tasks, power cycling, and firmware updates.

The expansion slot(s) 150 on the circuit board 102 may be used for connecting additional peripherals, such as GPUs, network cards, and more.

The other components 160 can include integrated components, replaceable components, and other suitable components. For example, these components may include but are not limited to sensors, cooling devices, power supply modules (and/or connectors), clock generators, chipsets, and more. In one or more embodiments, a chipset refers to a component or a group of components that manage communication between the CPU, memory (RAM), storage devices, network interfaces, and other peripherals.

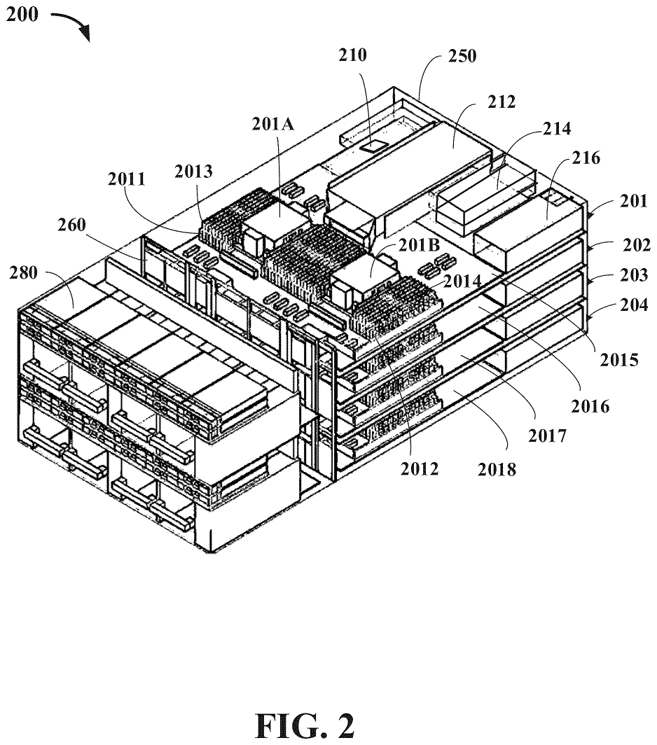

FIG. 2 illustrates a non-limiting example of a computing system 200 that includes multiple circuit boards. As shown in FIG. 2, the computing system 200 may be a server device that includes a first computing node 201, a second computing node 202, a third computing node 203, and/or a fourth computing node 204. The first computing node 201, the second computing node 202, the third computing node 203, and/or the fourth computing node 204 may be arranged within a housing (e.g., a chassis 250, which is shown in FIG. 2 with its top cover and a portion of side cover(s) removed) of the computing system 200. It is noted that, while the computing system 200 is illustrated in FIG. 2 to include four computing nodes, the total number of computing nodes included in the computing system 200 is not limited to four and can be any other applicable number such as one, two, three, five, or more.

In some embodiments, as shown in FIG. 2, the first computing node 201 may include a first processor 201A (e.g., CPU), a first set of slots 2011 (e.g., memory module slots, memory card slots, etc.) associated with the first processor 201A, and/or a first set of memory modules 2013 (or memory cards, or other memory devices) coupled to (e.g., electrically and physically) the first set of slots 2011 (e.g., memory module slots). The first processor 201A may be coupled to, or be disposed on, a first motherboard 2015. In some embodiments, the first set of slots 2011 may be, or may include, one or more memory module slots. In some embodiments, the one or more memory module slots may be, or may include, one or more Dual-Inline Memory Module (DIMM) slots. In this case, the first set of memory modules 2013 (or memory cards, or other memory devices) may be, or may include, one or more DIMMs, where the one or more DIMMs may be respectively coupled to (e.g., inserted into) the one or more DIMM slots.

For example, as shown in FIG. 2, the first set of slots 2011 may include eight DIMM slots disposed on a first side (e.g., left side) of the first processor 201A and eight DIMM slots disposed on a second side (e.g., right side) of the first processor 201A, where the second side is opposite to the first side. In this example, the first set of memory modules 2013 may be, or may include, multiple DIMMs each inserted into a corresponding DIMM slot. For instance, a DIMM from the first set of memory modules 2013 may be coupled to a memory bus of the first processor 201A, to interface with the first processor 201A. In some embodiments, a DIMM may include dynamic random access memory (DRAM) chips that are coupled to the printed circuit board. The one or more DRAM chips may include, for instance, one or more double data rate (DDR) DRAMs, and/or one or more synchronous dynamic random access memories (SDRAMs).

Additionally, or alternatively, the first computing node 201 may include a second processor 201B (e.g., CPU), a second set of slots 2012 associated with the second processor 201B, and/or a second set of memory modules 2014 coupled or connected to the second set of slots 2012. The second processor 201B may be coupled to, or be disposed on, the first motherboard 2015, e.g., along with the first processor 201A. The second set of slots 2012 may include one or more Dual Inline Memory Module (DIMM) slots disposed on the first motherboard 2015. For example, as shown in FIG. 2, the second set of slots 2012 may include eight DIMM slots disposed on a first side (e.g., left side) of the second processor 201B and eight DIMM slots disposed on a second side (e.g., right side) of the second processor 201B, where the second side is opposite to the first side. The second set of memory modules 2014 may be or may include, for instance, one or more DIMM modules each hosting one or more DRAM chips (e.g., SDRAMs, DDR DRAMs, etc.). In this example, a DIMM module may be coupled to the second processor 201B. For instance, a DIMM module may interface with the second processor 201B via a memory bus of the second processor 201B.

In some embodiments, as shown in FIG. 2, the first computing node 201 may further include one or more additional components. For example, as shown in FIG. 2, the one or more additional components of the first computing node 201 may include a controller 210 (e.g., BMC). In this example, the controller 210 may be coupled to, or be disposed on, the first motherboard 2015. In other examples, the controller 210 may be coupled to, or disposed on, another circuit board such as second motherboard 2016, third motherboard 2017, fourth motherboard 2018, or a datacenter-ready secure control module (DC-SCM) board. When the controller 210 is disposed on (or coupled to) the DC-SCM board, the DC-SCM board may be disposed on (e.g., physically connected to) the first motherboard 2015 or other circuit board (e.g., 2016, 2017, or 2018).

Additionally or alternatively, the one or more additional components of the first computing node 201 may further include a Peripheral Component Interconnect Express (PCIe) module 212 for connection with a PCIe device. Additionally, or alternatively, the one or more additional components may include a network interface card (NIC) 214. Additionally, or alternatively, the one or more additional components may include an AC-DC converter 216 that converts an alternating current (AC) from a wall outlet into direct current(s) (DC). The AC-DC converter 216 may include, for instance, one or more power supply units (PSUs).

In some embodiments, the first computing node 201 may include one or more power supplies (not shown in FIG. 2), one or more cooling units (not shown), one or more logic devices (e.g., CPLDs, not shown), and/or one or more connectors. The one or more power supplies can include, for instance, a first group of power supplies and a second group of power supplies. The first group of power supplies may include, for instance, a main power supply (or a plurality of main power supplies). The second group of power supplies may include, for instance, a standby power supply (or a plurality of standby power supplies). As a non-limiting example, the main power supply (e.g., 12 volts) may include one or more main power supply circuits (or chips) configured to supply power to the first processor 201A, the second processor 201B, and/or the one or more cooling units (e.g., fan(s), liquid cooling device(s), etc.), to ensure the running of computational component(s) of the first computing node 201. Additionally, or alternatively, the standby power supply (e.g., 5 volts, 3.3 volts, 2.5 volts, 1.8 volts, etc.) may include one or more standby power supply circuits (or chips) configured to supply power to component(s) such as drives and random access memories (RAMs), to ensure the running of essential functions for the first computing node 201.

In some embodiments, a PSU of the first computing node 201 may be coupled to the first group of power supplies, for the first group of power supplies to supply power to the first processor 201A and/or the second processor 201B, e.g., at the aforementioned first voltage level (e.g., 12V and/or 48V). Additionally, the PSU (or another PSU) of the first computing node 201 may be coupled to a first standby power supply circuit (or chip) from the second group of power supplies, for the first standby power chip to supply power at the aforementioned third voltage level (12V, or a lower voltage level). Similarly, the first standby power supply circuit may be coupled to a second standby power supply circuit for the second standby power supply circuit to supply voltage, e.g., at 3.3V, to the CPLD of the first computing node. It is noted that, the total number of different voltage levels provided by the standby power supply circuit(s) or the main power supply circuit(s), however, is not limited to two, and can be any other applicable number. Further, the specific voltage levels provided using the standby power supply circuit(s) are not limited to 12V and 3.3V, and can include, for instance, 5V, 1.8V, or any other applicable voltage level(s). Similarly, the specific voltage levels provided using the main power supply circuit(s) are not limited to 12V and 48V, and can include any other applicable voltage level(s).

In some embodiments, computing system 200 may include a controller power supply circuit (or chip) that supplies power to the controller 210 (e.g., BMC) at a certain voltage level (e.g., 3.3V). The controller power supply circuit may be coupled to a PSU that converts AC from a wall outlet to DC with a voltage level of 12V. Such controller power supply circuit may be configured to provide power supply to the controller 210, e.g., at a voltage level of 3.3V. In some embodiments, the controller power supply circuit is independent from the aforementioned main power supply circuit(s) and the standby power supply circuit(s), such that when the first computing node 201 (or other computing node(s)) is powered off, the controller power supply circuit still supplies power to the controller 210.

In some embodiments, the second computing node 202, the third computing node 203, or the fourth computing node 204 may each include the same or similar configuration as the first computing node 201, and repeated descriptions are omitted herein for the sake of brevity. In some embodiments, the first, second, third, and fourth computing nodes (201, 202, 203, 204) may be configured to be in communication with each other. In some embodiments, the computing system 200 may include a midplane circuit board 260 (“midplane”) that facilitates data and signal connections between one or more computing nodes of the computing system 200. In some embodiments, the midplane circuit board 260 may divide the chassis 250 into two regions: a first region for computing nodes (e.g., 201~204), and a second region for storage drives. For example, the computing system 200 may include one or more storage devices 280 disposed on, or coupled to, one or more backplanes. The one or more storage devices 280 may include, for instance, one or more solid state drives (SSDs) and/or one or more hard disk drives (HDDs).

In some embodiments, each motherboard (e.g., 2015, 2016, 2017, 2018) may include a controller (e.g., BMC) like controller 210. In some other embodiments, a plurality of motherboards may be coupled to a common controller. For example, the computing system 200 may include one and only one controller, i.e., the controller 210 (e.g., BMC). In this case, the single controller 210 may be coupled (e.g., directly or indirectly) to the first motherboard 2015, or may be coupled to any other applicable circuit board (e.g., the fourth motherboard 2018). The single controller 210 may be configured to control one or more components (e.g., CPLD and/or standby power supply) within each computing node (e.g., 201, 202, 203, 204) of the computing system 200. By including a single controller 210 within the computing system 200 while configuring the controller 210 to control components such as the CPLD of each computing node, as well as standby power of each computing node, of the computing system 200, the total number of controllers needed for the computing system 200 is reduced (e.g., to one), the overall power consumption of the computing system 200 is decreased, and the overall computing capabilities of the computing system can be flexibly adjusted. Accordingly, the cost and time associated with arranging or customizing a controller for each computing node is reduced or prevented, while the overall power consumption and/or overall computing capabilities of the computing system can be flexibly and automatically controlled. Detailed descriptions of the connections between various components of the computing system 200 to implement the disclosed methods and systems can be found later in this specification.

It will be understood that various components described in connection with each computing node and each motherboard are provided by way of example only for purposes of illustration. The configuration of each computing node and motherboard can include any suitable set of components.

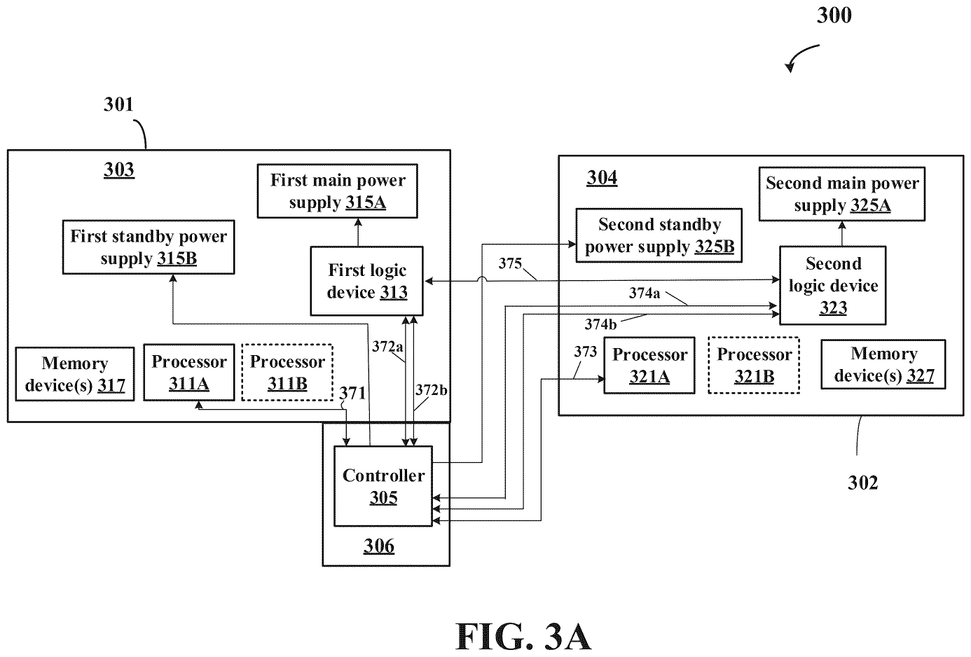

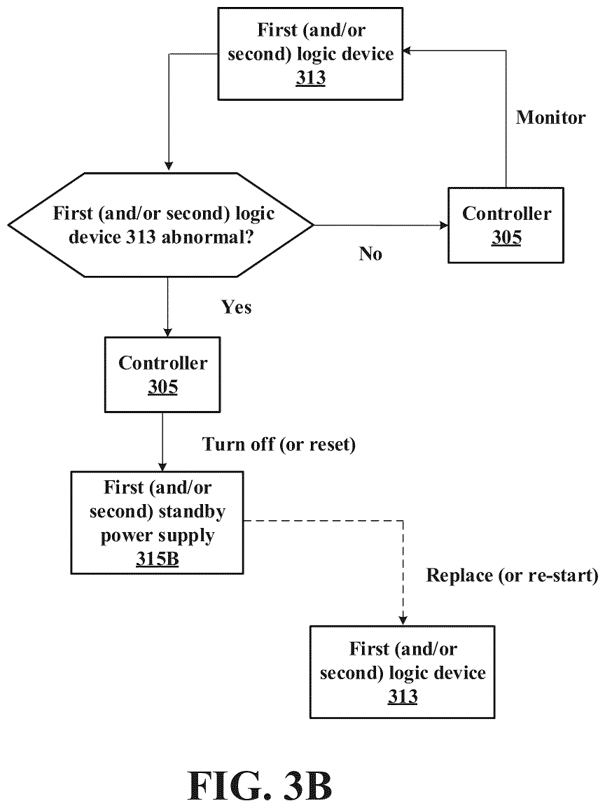

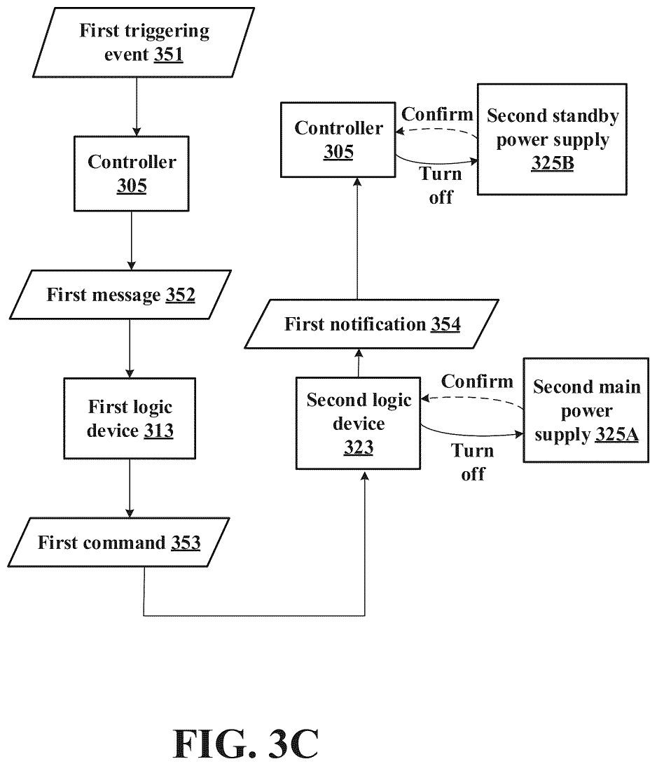

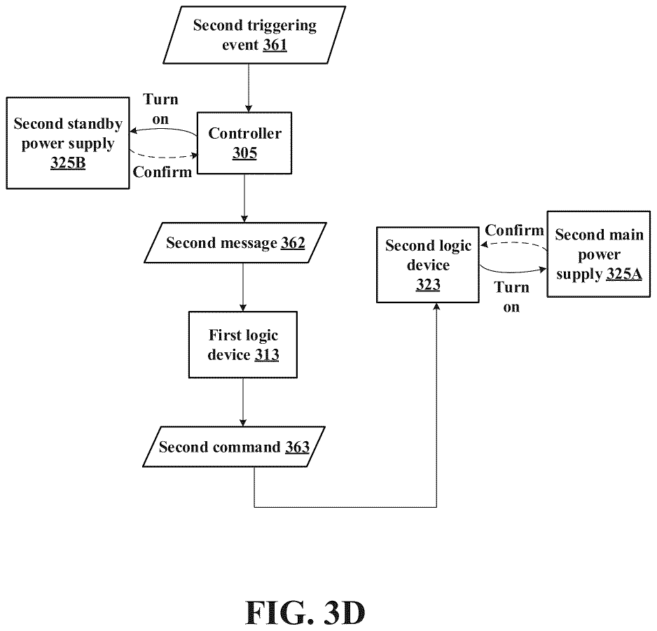

FIG. 3A illustrates a block diagram showing two computing nodes of an example computing system 300. FIG. 3B illustrates a flow chart showing a process where a logic device (e.g., CPLD) is powered off or reset in response to detect an abnormal condition of the logic device. FIG. 3C illustrates a flow chart showing a process where one of the computing nodes is automatically powered off to reduce power consumption. FIG. 3D illustrates a flow chart showing another process where one of the computing nodes is automatically powered on to increase computational capability.

As shown in FIG. 3A, the computing system 300 may include a first computing node 301 disposed on a first circuit board 303, and a second computing node 302 disposed on a second circuit board 304. The first circuit board 303 may be a motherboard or other applicable circuit board. The second circuit board 304 may be a motherboard or other applicable circuit board. The computing system 300 may further include a controller 305 disposed on a third circuit board 306. The controller 305 may be a baseboard management controller (BMC). The third circuit board 306 may be a secure control module (SCM) board, or may be the first circuit board 303. For example, the SCM board may be a datacenter-ready secure control module (DC-SCM) board, and the controller 305 may be disposed on, or couped to, the DC-SCM board. The DC-SCM board may be attached to, in proximity with, or coupled to the first circuit board 303.

In some embodiments, the first computing node 301 may include a first set of processors (e.g., 311A and/or 311B), a first logic device 313, a first set of power supplies (e.g., 315A and/or 315B), and/or a first set of memory devices 317. For example, as shown in FIG. 3A, the first set of processors 311 may include a processor 311A and/or a processor 311B, where the processor 311B may be in communication with the processor 311A. The processor 311A and the processor 311B may be of the same type, or may be of different types. In some embodiments, the processor 311A may be a CPU or other applicable type of processor (e.g., GPU). Additionally, or alternatively, the processor 311B may be a CPU or other applicable type of processor (e.g., GPU). The first set of memory devices 317 may include one or more RAM devices (e.g., DRAM(s)). The first set of memory devices 317 may be in communication with the processor 311A (and/or the processor 311B). Accordingly, the first set of memory devices 317 may be in communication with the controller 305, e.g., via the processor 311A or other communication path.

In some embodiments, the processor 311A may be connected to the controller 305 via a first communication link 371. Based on the communication(s) between the processor 311A, the processor 311B, and the first set of memory devices 317 and/or based on the first communication link 371, the controller 305 may be configured to acquire a utilization rate of the processor 311A, a utilization rate of the processor 311B, and/or utilization rate(s) of the first set of memory devices 317, to determine a work load condition (e.g., light, heavy, etc. as determined based on threshold values, which may for example, be based on a percentage of utilization) of the first computing node 301. In some embodiments, a communication protocol of the first communication link 371 may be or may include Universal Asynchronous Receiver/Transmitter (UART) or any other applicable protocol (e.g., I2C, USB, etc.).

In some embodiments, the first logic device 313 may be a programmable logic device such as a complex programmable logic device (CPLD) or a Field-Programmable Gate Array (FPGA). The first logic device 313 may be connected to the controller 305 via a first set of communication links, where the first set of communication links may include a communication link 372a with a first data transmission rate and/or a communication link 372b with a second data transmission rate (which may be different from the first data transmission rate). In some embodiments, the communication link 372a may have a high data transmission (e.g., higher than communication link 372b) rate, and the communication link 372b may have a low data transmission rate (e.g., lower than communication link 372a). For example, a protocol of the communication link 372a may be, but is not limited to, inter-integrated circuit (I2C) or improved inter-integrated circuit (I3C) or a Serial Peripheral Interface (SPI) protocol, and a protocol of the communication link 372 b may be UART having a data transmission rate slower than 372a. Depending on the specific model of the I2C or UART, in some other examples, the protocol of the communication link 372a may be UART, and the protocol of the communication link 372b may be I2C having a data transmission rate slower than 372a.

In some embodiments, the first set of power supplies may include a first main power supply 315A coupled to the first logic device 313, and/or a first standby power supply 315B coupled to the controller 305. For example, the first main power supply 315A may be connected (e.g., directly) to the first logic device 313, and the first standby power supply 315B may be directly connected (e.g., directly) to the controller 305. In some embodiments, the first main power supply 315A is configured to supply power to the processor 311A and/or the processor 311B, and the first standby power supply 315B is configured to ensure the running of essential functions for the first computing node 301. For example, the first standby power supply 315B may be configured to at least supply power (e.g., at a voltage level of 3.3V) to the first set of memory devices 317 and/or other component(s) such as the first logic device 313.

In some embodiments, the first main power supply 315A includes more than one main power supply circuit (or chip), to provide power supply at one or more voltage levels (e.g., 12V and/or 48V). Additionally, or alternatively, the first standby power supply 315B includes more than one standby power supply circuit (or chip), to provide power supply at one or more additional voltage levels (e.g., 12V, 5V, 3.3V, 1.8V, etc.). For example, the first main power supply 315A may include one or more additional main power supplies (e.g., a first additional main power supply), in addition to the first main power supply 315A. For example, the first main power supply 315A and the first additional main power supply may be configured to provide voltage levels such as 12 volts. Additionally, or alternatively, the first standby power supply 315B may include one or more additional standby power supplies (e.g., a first additional standby power supply), in addition to the first standby power supply 315B. The first standby power supply 315B and the first additional standby power supplies may be configured to provide voltage levels such as 5 volts, 3.3 volts, etc.

In some embodiments, the controller 305 may be configured to control (e.g., turn on or turn off) the first standby power supply 315B (and other additional standby power supply on the first circuit board 303, if any) for the first computing node 301. For example, the controller 305 may transmit an “Enable” signal to the first standby power supply 315B via a direct communication link between the controller 305 and the first standby power supply 315B, to turn on first standby power supply 315B. In some embodiments, the first logic device 313 (e.g., a first CPLD) may be configured to control (e.g., turn on or off) the first main power supply 315A (and other additional main power supply on the first circuit board 303, if any) for the first computing node 301. For example, the first logic device 313 may transmit an “Enable” signal to the first main power supply 315A via a direct communication link between the first logic device 313 and the first main power supply 315A, to turn on the first main power supply 315A.

In some embodiments, referring to FIG. 3A and FIG. 3B, the controller 305 may be configured to monitor an operating condition of the first logic device 313 (e.g., periodically or in real-time) and/or other logic device(s) (if any) of the computing system 300, and in response to detecting that the first logic device 313 is abnormal (e.g., fail or malfunction), the controller 305 may be configured to perform one or more remedial actions. For example, in response to detecting that the first logic device 313 is abnormal, the controller 305 may control the first standby power supply 315B by turning off the first standby power supply 315B, and/or generate an alert indicating that the first logic device 313 is abnormal, such that the first logic device 313 can be replaced or go through maintenance. It is noted that, turning off the first standby power supply 315B that supplies power to the first logic device 313 may cause the first logic device 313 to stop operation, which results in the first main power supply 315A (controlled using the first logic device 313) to be turned off. In other words, turning off the first standby power supply 315B (e.g., using the controller 305) in response to determining that the first logic device 313 is abnormal may result in the first circuit board 301 (e.g., first motherboard) to be powered off, thus facilitating the first logic device 313 to be removed or detached from the first circuit board 301.

Additionally or alternatively, in response to detecting that the first logic device 313 is abnormal, the controller 305 may control the first standby power supply 315B by re-starting the first standby power supply 315B, e.g., to determine whether the first computing node 301 can be re-started, prior to replacing or maintaining the first logic device 313 (or prior to issuing an alert for replacement or maintenance of the first logic device 313).

In some embodiments, the controller 305 may be configured to obtain an utilization rate of the processor 311A (and/or an utilization rate of the processor 311B) of the first computing node 301 based on the first communication link 371 between the processor 311A and the controller 305. In some embodiments, the processor 311A is in communication with the processor 311B (if exists), the first set of memory devices 317, as well as processor(s) and memory from other computing node(s). For example, the processor 311A may be in communication with the processor 311B (e.g., via UPI or GMII interconnect), the first set of memory devices 317, as well as a processor 321A, a processor 321B, and a second set of memory devices 327 from the second computing node 302. As a result, by inquiring the processor 311A of the first computing node 301 through the first communication link 371, the controller 305 not only obtain an utilization rate of the processor 311A, but also obtain an utilization rate of the processor 311B (if exists), an utilization rate of the first set of memory devices 317, an utilization rate of the processor 321A, an utilization rate of the processor 321B (if exists), and an utilization rate of the second set of memory devices 327. The controller 305 may be configured to obtain each of the above-mentioned utilization rates, a total utilization rate of all processors, and/or a total utilization rate of all memory devices, either periodically (e.g, every 0.5 s or any other suitable interval) or in real-time.

It is noted that, in some embodiments, additionally, or alternatively, the controller 305 may obtain the utilization rate of the processor 321A, the utilization rate of the processor 321B (if exists), and the utilization rate of the second set of memory devices 327 based on a third communication link 373 between the controller 305 and the processor 321A of the second computing node 302.

In some embodiments, the second computing node 302 may include a second set of processors (e.g., 321A and/or 321B), a second logic device 323, a second set of power supplies (e.g., 325A and/or 325B), and/or the second set of memory devices 327. In some embodiments, the second set of processors 321 may include, for instance, the processor 321A and/or the processor 321B (which may be the same as, or different from the processor 321A). The processor 321A may be a CPU or other applicable type of processor (e.g., GPU). Additionally, or alternatively, the processor 321B may be a CPU or other applicable type of processor (e.g., GPU). In some embodiments, processor(s) of the first computing node 301 may be the same as, partially different from, or completely different from processor(s) of the second computing node 302. For example, the processor 311A of the first computing node 301 may be a CPU, and the processor 321A of the second computing node 302 may be another CPU. As another example, the processor 311A of the first computing node 301 may be a CPU, and the processor 321A of the second computing node 302 may be a GPU (TPU, or NPU, or any other applicable type of processor). In some embodiments, as mentioned previously, the processor 321A (or the processor 321B) may be connected to the controller 305 via the third communication link 373, but this is not required, as the controller 305 may obtain the utilization rate of the processor 321A (that is on, or coupled to, the second circuit board 304) via the processor 311A (that is on the first circuit board 303). A communication protocol of the third communication link 373 may be, or may include, UART or any other applicable protocol.

In some embodiments, the second logic device 323 may be a programmable logic device such as a complex programmable logic device (CPLD) or a Field-Programmable Gate Array (FPGA). The second logic device 323 may be connected to the controller 305 via a second set of communication links (e.g., a communication link 374a with a third data transmission rate and/or a communication link 374b with a fourth data transmission rate different from the third data transmission rate). For example, a protocol of the communication link 374a may be I2C or I3C, and a protocol of the communication link 374b may be UART. The second set of memory devices 327 may include one or more RAM devices (e.g., DRAM(s)). In this example, the third data transmission rate may be the same as (or different from) the aforementioned first data transmission rate, and the fourth data transmission rate may be the same as (or different from) the aforementioned second data transmission rate.

In some embodiments, the second set of power supplies 325 may include a second main power supply 325A coupled to the second logic device 323, and/or a second standby power supply 325B coupled to the controller 305. As a non-limiting example, the second main power supply 325A may be configured to supply power to the processor 321A (and/or processor 321B), and the second standby power supply 325B may be configured to supply power to the second set of memory devices 327 and/or other component(s), such as the second logic device 323, to ensure essential functions of the second computing node 302.

In some embodiments, the controller 305 may be configured to control (e.g., turn on or turn off) the second standby power supply 325B for the second computing node 302, and the second logic device 323 may be configured to control (e.g., turn on or off) the second main power supply 325A for the second computing node 302. In some embodiments, referring to FIG. 3B, the controller 305 (or the first logic device 313) may be configured to monitor an operating condition of the second logic device 323 (e.g., periodically or in real-time), and in response to detecting an abnormal condition (e.g., failure) of the second logic device 323, the controller 305 (or the first logic device 313) may be configured to perform one or more remedial actions. For example, the controller 305 may control the second standby power supply 325B to turn off the second standby power supply 325B, restart the second standby power supply 325B, and/or generate one or more alerts. Similar descriptions can be found previously and repeated descriptions are omitted herein for the sake of brevity.

In some embodiments, the first logic device 313 may be in communication with (e.g., connected to) the second logic device 323, e.g., via a communication interface 375. The first logic device 313 may be configured to, for instance, monitor or control the second logic device 323, where the second logic device 323 controls the second main power supply 325A for the second computing node 302. In some embodiments, the communication interface 375 may be, for instance, a low voltage differential signaling (LVDS) interface that enables high-speed digital communication, so that the second logic device 323 can receive command(s) or signals from the first logic device 313 quickly. In some other embodiments, the communication interface 375 may be based on the I2C protocol (which may provide data transmission rate slower than LVDS) or based on the SPI protocol.

The first logic device 313 (or the controller 305) may be configured to monitor the operating condition of the second logic device 323 based on the high-speed communication link 375 (LVDS) interface between the first logic device 313 and the second logic device 323, or the controller 305 may be configured to monitor the operating condition of the second logic device 323 based on the communication link 374a (or 374b). As a non-limiting example, when the first logic device 313 is operating in a normal condition, the controller 305 may monitor the second logic device 323 based on the high-speed communication link 375 (LVDS) interface between the first logic device 313 and the second logic device 323 and based on the communication link 372a. In this example, when the first logic device 313 is in an abnormal condition (e.g., malfunction, not responsive for a predefined duration), the controller 305 may monitor the second logic device 323 based on the communication link 374a (or 374b).

In some embodiments, by configuring the communication interface 375 between the first logic device 313 and the second logic device 323 to be a high-speed LVDS interface, the first logic device 313 may be configured to monitor the operating condition of the second logic device 323 based on the high-speed communication LVDS interface, and the first logic device 313 may notify the controller 305 to power off (or reset or restart) the second standby power supply 325B in response to detecting an abnormal condition of the second logic device 323. Further, based on the communication interface 375 (e.g., LVDS interface) between the first logic device 313 and the second logic device 323, the controller 305 may be in communication with the second logic device 323 via a first route formed using the communication link 372a (which may be based on the I2C protocol, or alternatively, communication link 372b in case the link 372a fails) and the communication interface 375, where the first route provides data communication with a relatively high speed. It is noted that, in case the communication interface 375 fails, the controller 305 may still communicate with the second logic device 323 via other communication link(s) such as the communication link 374a (or 374b).

In some embodiments, referring to FIG. 3A and FIG. 3C, the controller 305 may be configured to detect a first triggering event 351 that triggers the second computing node 302 to be powered off. The first triggering event 351 may be an event at which the utilization rate of the processor 311A (or the processor 311B, if any, or a combination thereof) of the first computing node 301 is determined to be below a first processor utilization rate threshold (e.g., 20%) for a first time period (e.g., 5 min) and/or at which the utilization rate of the first set of memory devices 317 (or a portion thereof) of the first computing node 301 is determined to be below a first memory utilization rate threshold (e.g., 30%) for a second time period (e.g., 5 min). The first time period may be the same as, or different from, the second time period. The first processor utilization rate threshold (e.g., 20%) may be a lower limit for processor utilization rate, and the second memory utilization rate threshold (e.g., 30%) may be a lower limit for memory utilization rate. The detection of the first triggering event 351 may cause a first set of actions that powers off the second computing node 302 to be performed.

For example, in response to detecting the first triggering event 351 that indicates that a computing load of the computing system 300 is low (e.g., the total utilization rate of both the processor 311A and the processor 311B is approximately 18%, the utilization rate of each of the processor 311A and processor 311b is approximately 18%, the utilization rate of each of the first set of memory devices 317 and the second set of memory devices 327, and/or the total utilization rate of the memory devices 317 and memory devices 327 is approximately 28% for at least 5 min), the controller 305 may generate and/or transmit a first message 352 (or a first signal) to the first logic device 313. The first message 352 may include content that instructs the first logic device 313 to generate (and/or transmit) a first command 353 (that powers/turns off the second main power supply 325A for the second computing node 302). In response to receiving the first message 352 from the controller 305, the first logic device 313 for the first computing node 301 may generate and/or transmit the first command 353 to the second logic device 323. In response to receiving the first command 353 from the first logic device 313, the second logic device 323 may control the second main power supply 325A to be turned/powered off. In this way, the processor 321A (and/or the processor 321B, if exists) to which the second main power supply 325A supplies power, may be turned off, which reduces the overall power consumption of the computing system 300.

In some embodiments, prior to transmit the first command 353 to the second logic device 323, an operating system of the computing system 300 may be configured to re-allocated one or more tasks previously allocated to the second computing node 302, to other computing node (e.g., the first computing node 301). In this way, data loss and interruption (or missing) of task(s) may be avoided. It is noted that the aforementioned first processor utilization rate threshold (e.g., 20%) may be determined based on the total number, type(s), and other parameters associated with processors (e.g., 311A, 311B, 321A, 321B) of the computing system 300. For example, given the total number of the processors of the computing system 300 being two (e.g., 311A and 321A) and given that a utilization rate is approximately 18% for each of the processor 311A and the processor 321A, re-allocating tasks performed using the processor 321A to the processor 311A and powering off the processor 321A afterwards may increase the utilization rate of the processor 311A to approximately 36%. Such utilization rate of the processor 311A is still not too heavy for the first computing node 301, while the overall power consumption of the computing system 300 is greatly reduced due to power supply to the processor 321A being turned off.

In some embodiments, continuing with the example above and further referring to FIG. 3C, in response to determining that the second main power supply 325 has been turned off, the second logic device 323 may further transmit a first notification 354 to the controller 305, where the first notification 354 notifies the controller 305 that the second main power supply 325A has been turned off. In response to receiving the first notification 354 from the second logic device 323, the controller 305 may control the second standby power supply 325B (which may supply power to the second set of memory devices 327 and/or the second logic device 323) to be powered off. In this way, the second main power supply 325A and the second standby power supply 325B for the second computing node 302, that supply power to various components of the second computing node 302, are both turned off. The overall power consumption of the computing system 300 is therefore further reduced (as the power consumption of the second computing node 302 is reduced to approximately zero or other low power amount), without negatively affecting the computational performance of the computing system 300 (as the first computing node 301 is sufficient to perform the desired tasks).

It is noted that, the second logic device 323 may transmit the first notification 354 to the controller 305 indirectly via the first logic device 313 (e.g., using a first data transmission path formed using the LVDS interface 375 and the communication link 372a (or 372b)). For example, the second logic device 323 may transmit the first notification 354 to the first logic device 313 via the high-speed LVDS interface between the first logic device 313 and the second logic device 323, and the controller 305 may receive the first notification 354 from the first logic device 313 through the communication link 372a which may have a higher data transmission rate than the communication link 372b. Alternatively, the second logic device 323 may transmit the first notification 354 to the controller 305 directly based on a direct connection (e.g., a second data transmission path formed using communication link 374a or 374b) between the second logic device 323 and the controller 305. For example, if the first notification 354 is lost during transmission via the LVDS interface 375 or the communication link 372a, the second logic device 323 may transmit the first notification 354 to the controller 305 via the communication link 374a. In other words, the disclosed system and method provide at least two data transmission paths for the controller 305 to receive the first notification 354 from the second logic device 323, which ensures that the controller 305 can be quickly notified of the turn-off of the second main power supply 325A, before the controller 305 proceeds to turn off the second standby power supply 325B.

In some embodiments, referring to FIG. 3A and FIG. 3D, the controller 305 may be configured to detect a second triggering event 361 that triggers the second computing node 302 to be powered/turned on. For example, the second triggering event 361 may be an event at which the utilization rate of the processor(s) (e.g., 311A and/or 311B) of the first computing node 301 is determined to be beyond a second processor utilization rate threshold (e.g., 80%) for a first duration (e.g., 5 min), the utilization rate of the processor(s) (321A and/or 321B) of the second computing node 302 is determined to be beyond the second processor utilization rate threshold (e.g., 80%) for the first duration (e.g., 5 min), the utilization rate of the first set of memory devices 317 (or a portion thereof) of the first computing node 301 is determined to be beyond a second memory utilization rate threshold (e.g., 90%) for a second duration (e.g., 5 min), and/or the utilization rate of the second set of memory devices 327 (or a portion thereof) of the second computing node 302 is determined to be beyond the second memory utilization rate threshold (e.g., 90%) for the second duration (e.g., 5 min).

As another example, the second triggering event 361 may be an event at which the total utilization rate of the processors (e.g., 311A, 311B, 321A, 321B) of the computing system 300 is determined to be beyond the second processor utilization rate threshold (e.g., 80%) for the first duration (e.g., 5 min), and/or at which the total utilization rate of the memory devices (e.g., 317 and 327) of the computing system 300 is determined to be beyond the second memory utilization rate threshold (e.g., 90%) for the second duration (e.g., 5 min). The second processor utilization rate threshold (e.g., 80%) may be an upper limit for processor utilization rate and can be greater than or equal to the first processor utilization rate threshold (e.g., 20%, which may be a lower limit for processor utilization rate). The second memory utilization rate threshold (e.g., 90%) may be an upper limit for memory utilization rate and can be greater than or equal to the first memory utilization rate threshold (e.g., 30%, which may be a lower limit for memory utilization rate).

The detection of the second triggering event 361 may cause a second set of actions that powers on the second computing node 302 to be performed. For example, in response to detecting the second triggering event 361 that indicates that a computing load of active processors (and/or memory devices) of the computing system 300 is high (e.g., the utilization rate of each of the processors (e.g., 311A, 311B) of the first computing node 301 is greater than 80% for at least 5 min and/or the utilization rate of each memory device (from the first set of memory devices 317) is greater than 90% for at least 5 min), the controller 305 may control the second standby power supply 325B to be turned on. The second standby power supply 325B may then supply power (e.g., at voltage levels of 3.3V and 5V) to one or more components (e.g., second set of memory devices 327, and/or second logic device 323) of the second computing node 302. In some embodiments, it is noted that, the one or more components to which the second standby power supply 325B supplies power may not include processor(s) (e.g., the processor 321A or 321B) of the second computing node 302. In some embodiments, the second main power supply 325A is configured to supply power to the processor(s) (e.g., the processor 321A or 321B) of the second computing node 302.

In response to determining that the second standby power supply 325B has been turned on, the controller 305 may generate and/or transmit a second message 362 to the first logic device 313, where the second message 362 instructs the first logic device 313 to generate (and/or transmit) a second command 363 that powers on the second main power supply 325A for the second computing node 302. In response to receiving the second message 362 from the controller 305, the first logic device 313 for the first computing node 301 may generate and/or transmit the second command 363 to the second logic device 323. It is noted that, the disclosed system and method allows the second logic device 323 to be turned on in response to the second standby power supply 325B being turned on, such that the second logic device 323 can operate to receive the second command 363 from the first logic device 313.

In response to receiving the second command 363 from the first logic device 313, the second logic device 323 may control the second main power supply 325A to be turned/powered on, which may supply power to the processor 321A (and/or the processor 321B). In this way, the second computing node 302 is powered on, and can be configured to perform one or more tasks (e.g., re-allocated from the first computing node 301), which therefore shares the computational load with the first computing node 301, or reduces the computational load of the first computing node 301. As a result, the computational capabilities of the computing system 300 is increased or balanced, and the work load of each computing node may be reduced, to prevent issues such as overheat, etc.

According to the present disclosure, by monitoring the utilization rate of the processors (311A and/or 311B) of the first computing node 301 (and/or other computing node(s)) and/or by monitoring the utilization rate of the first set of memory devices 317 of the first computing node 301 (and/or of other computing node(s)), whether to power on or power off the second computing node 302 can be determined automatically, without manual human operation. For example, by automatically powering off the second computing node 302 when the computational load of the computing system 300 is determined to be light (e.g., below a threshold), the overall power consumption of the computing system can be reduced. In fact, by configuring the controller 305 to individually control the standby power supply for each computing node, the disclosed method and system may select and control one or more particular computing nodes (e.g., the aforementioned second computing node 302) to be automatically turned off (instead of merely entering a “standby” mode as mentioned previously), in response to detection of the first triggering event (which indicates the computational load of the first computing node 301 is light, e.g., below a predetermined value of computational load). Turning off the one or more particular computing nodes allows these nodes to no longer consume any power, which reduces the overall power consumption of the computing system 300.

Further, by automatically powering on the second computing node 302 (e.g., powering on processors of the second computing node 302) when the computational load of the first computing node 301 is determined to be heavy (e.g., above a threshold), the computational capability and efficiency of the computing system 300 can be increased. Further, by configuring the controller 305 to be in communication with both the first logic device 313 and the second logic device 323, remedial action(s) such as immediate power off or re-start of a computing node can be instantly performed in response to the computing node (e.g., a logic device) being detected to be in an abnormal condition.

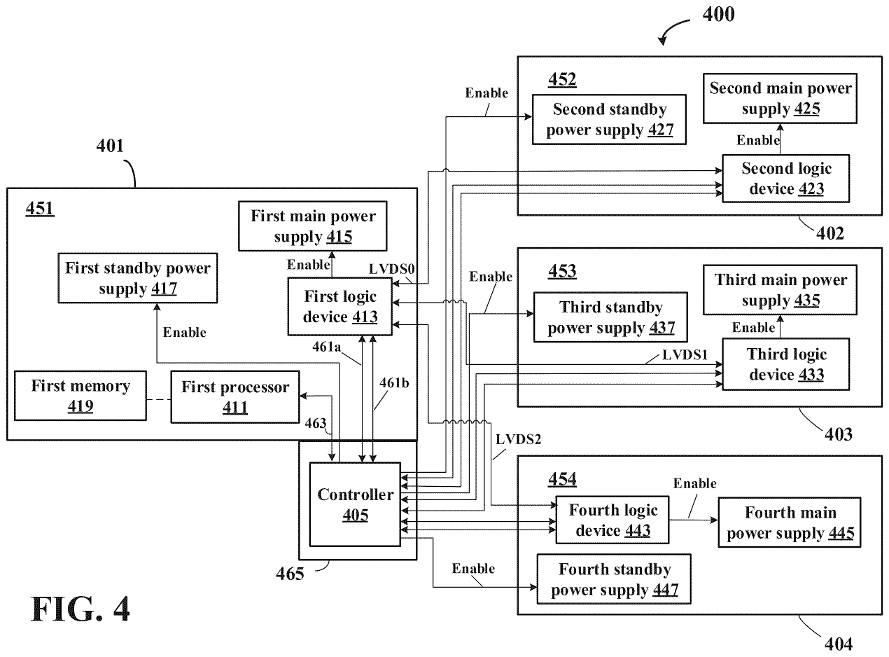

While the multiple computing nodes in FIG. 3A~3D are illustrated to include first and second computing nodes, the total number of multiple computing nodes for a disclosed computing system is not limited to two and can be any other applicable value (e.g., 3, 4, 5, or more). For example, FIG. 4 illustrates a block diagram showing an example computing system 400 having four computing nodes. As shown in FIG. 4, the computing system 400 may include a first computing node 401, a second computing node 402, a third computing node 403, and/or a fourth computing node 404. The first computing node 401 may include or be disposed on the first circuit board 451. The second computing node 402 may include or be disposed on a second circuit board 452. The third computing node 403 may include or be disposed on a third circuit board 453. The fourth computing node 404 may include or be disposed on a fourth circuit board 454. The first, second, third, or fourth circuit board may be a motherboard or any other applicable circuit board.

In some embodiments, the first computing node 401 may include a first processor (e.g., CPU 411), a first programmable logic device 413 (e.g., CPLD 413), a first main power supply 415, a first standby power supply 417, and/or a first memory 419. The first memory 419 may include one or more memory devices. While the first computing node 401 is depicted to include a single processor, the total number of the processors included in the first computing node 401 can be more than one (e.g., two or more). The second computing node 402 may include a second programmable logic device 423 (e.g., CPLD 423), a second main power supply 425, and/or a second standby power supply 427. The second computing node 402 may further include one or more processors (not shown) and one or more memory devices (not shown).

The third computing node 403 may include a third programmable logic device 433 (e.g., CPLD 433), a third main power supply 435, and/or a third standby power supply 437. The third computing node 403 may further include one or more processors (not shown) and one or more memory devices (not shown). The fourth computing node 404 may include a fourth programmable logic device 443 (e.g., CPLD 443), a fourth main power supply 445, and/or a fourth standby power supply 447. The fourth computing node 404 may further include one or more processors (not shown) and one or more memory devices (not shown).

In some embodiments, the computing system 400 may further include a controller 405 disposed on a fifth circuit board 465. The controller 405 may be a baseboard management controller (BMC). The fifth circuit board 465 may be a SCM board (e.g., DC-SCM board), or may be part of the first circuit board 431. For instance, the fifth circuit board 465 may be disposed on a same layer as the first circuit board 431, where the first circuit board 431 is disposed on a different layer with respect to the second, third, or fourth circuit board. For instance, the first circuit board 431 may be disposed above the second circuit board 432, the second circuit board 432 may be disposed above the third circuit board 433, and the third circuit board 433 may be disposed above the fourth circuit board 434. The first, second, third, fourth, and/or fifth circuit boards may be stored in a housing (e.g., chassis 250 in FIG. 2) of the computing system 400 (e.g., a server device). As another example, the fifth circuit board 465 may be coupled to, disposed on, or attached to the first circuit board 431. In this example, the controller 405 may therefore be coupled to the first circuit board 431.

In some embodiments, the controller 405 may be connected directly (or indirectly) to the first standby power supply 417, the second standby power supply 427, the third standby power supply 437, and the fourth standby power supply 447. The controller 405 may control the first standby power supply 417 to turn on or off the first standby power supply 417. The controller 405 may control the second standby power supply 427 to turn on or off the second standby power supply 427. The controller 405 may control the third standby power supply 437 to turn on or off the third standby power supply 437. The controller 405 may control the fourth standby power supply 447 to turn on or off the fourth standby power supply 447.

In some embodiments, the first CPLD 413 may be connected to the first main power supply 415, to control the on and off of the first main power supply 415. In some embodiments, the first CPLD 413 may be connected to the second CPLD 423, the third CPLD 433, and the fourth CPLD 443, respectively, via a respective communication link (e.g., a high-speed communication channel adopting a LVDS protocol). In this case, the first CPLD 413 may be configured to control the second CPLD 423, the third CPLD 433, and the fourth CPLD 443, respectively.

For example, the second CPLD 423 may be connected to the second main power supply 425, to control the on and off of the second main power supply 425. The third CPLD 433 may be connected to the third main power supply 435, to control the on and off of the third main power supply 435. The fourth CPLD 443 may be connected to the fourth main power supply 445, to control the on and off of the fourth main power supply 445. In this example, by connecting the first CPLD 413 with the second, third, and fourth CPLDs, respectively, the first CPLD 413 may be configured to control the on or off of the second main power supply 425, the third main power supply 435, and the fourth main power supply 445, respectively.

For example, the first CPLD 413 may be configured to control the on or off of the second main power supply 425, via the second CPLD 423. For instance, the first CPLD 413 may transmit a command to turn on (or off) the second main power supply 425, to the second CPLD 423, where the second CPLD 423 may turn on (or off) the second main power supply 425 to which it connects, based on the command. Additionally, or alternatively, the first CPLD 413 may be configured to control the on (or off) of the third main power supply 435, via the third CPLD 433 and/or based on a corresponding command to turn on (or off) the third main power supply 435. The first CPLD 413 may be configured to control the on (or off) of the fourth main power supply 445, via the fourth CPLD 443 and/or based on a corresponding command to turn on (or turn off) the fourth main power supply 445.

In some embodiments, the controller 405 may be connected to the first CPLD 413, the second CPLD 423, the third CPLD 433, and the fourth CPLD 443, respectively. One or more communication links may be configured between the controller 405 and a respective CPLD (e.g., 413, 423, 433, or 443). For example, the one or more communication links may include a communication link 461a having a first data transmission rate and a second communication link 461b having a second data transmission rate (that is different from the first data transmission rate). As a non-limiting example, the communication link having the first data transmission rate may be a I2C link (or a I3C link), and the second communication link having the second data transmission rate may be a UART communication link. By connecting the controller 405 with the first CPLD 413, the second CPLD 423, the third CPLD 433, and the fourth CPLD 443, the controller 405 may monitor a health condition of each of the first, second, third, and fourth CPLDs. For example, in response to detecting that a particular CPLD from the first, second, third, and fourth CPLDs (e.g., 413, 423, 433, 443) is in an abnormal condition (e.g., malfunction), the controller 405 may be configured to perform remedial actions such as turning off a standby power supply that supplies power to the particular CPLD, re-starting the standby power supply for a computing node that includes the particular CPLD, and/or generating an alert message.

In some embodiments, the controller 405 is connected to the first CPU 411 via a communication link 463. A communication protocol of the communication link 463 may include UART or any other applicable protocol. The controller 405 may be configured to obtain an utilization rate of the first CPU 411 of the first computing node 401 based on the communication link 463 between the first CPU 411 and the controller 405. Additionally, or alternatively, the controller 405 may be configured to obtain an utilization rate of the first memory 419 of the first computing node 401. The controller 405 may acquire the utilization rate of the first CPU 411 periodically or in real-time. The controller 405 may acquire the utilization rate of the first memory 419 periodically or in real-time.

It is noted that, the first CPU 411 may be in communication with other processor(s) and/or memories of the computing system 400, e.g., via interfaces such as UPI or GMII. Accordingly, based on the communication link 463, the controller 405 may be configured to acquire utilization rate of each processor of the computing system 400, and/or acquire utilization rate of each memory of the computing system 400. In some embodiments, the first processor 411 (or a different processor in communication with the controller 405) may be configured to determine a total utilization rate of the processors (e.g., including 411) the computing system 400. Additionally, or alternatively, the first processor 411 (or a different processor in communication with the controller 405) may be configured to determine a total utilization rate of the memories (e.g., including first memory 419) of the computing system 400

In some embodiments, the controller 405 may be configured to detect a first triggering event that triggers one or more computing nodes to be powered off. The first triggering event may be an event at which the utilization rate of a single processor (e.g., the first CPU 411 of the first computing node 401, or another processor at another computing node) is determined to be below a first processor utilization rate threshold (e.g., 20%) for a first time period (e.g., 5 min) and/or at which the utilization rate of a single memory (e.g., the first memory 419 of the first computing node 401, or another processor at another computing node) is determined to be below a first memory utilization rate threshold (e.g., 30%) for a second time period (e.g., 5 min). The first time period may be the same as, or different from, the second time period.

As another example, the first triggering event may be an event at which the utilization rate (e.g., total utilization rate) of one or more processors (e.g., all processors) of the computing system 400 is below the first processor utilization rate threshold (e.g., 20%) for the first time period (e.g., 5 min), and/or at which the utilization rate (e.g., total utilization rate) of one or more memories (e.g., all memories) of the computing system 400 is below the first memory utilization rate threshold (e.g., 30%) for the second time period (e.g., 5 min). As a further example, the first triggering event may be an event at which the utilization rate of each processor from one or more processors (e.g., all processors) of the computing system 400 is below the first processor utilization rate threshold (e.g., 20%) for the first time period (e.g., 5 min), and/or at which the utilization rate (e.g., total utilization rate) of each memory from one or more memories (e.g., all memories) of the computing system 400 is below the first memory utilization rate threshold (e.g., 30%) for the second time period (e.g., 5 min).

The detection of the first triggering event may cause a first set of actions that powers off one or more computing nodes to be performed. For example, in response to detecting the first triggering event that indicates that a computing load of the first computing node 401 is low (e.g., the utilization rate of the first CPU 411 is below 20% for at least 5 min and/or the utilization rate of the first memory 419 is below 30% for at least 5 min), the controller 405 may generate and/or transmit a first message to the first CPLD 413, where the first message instructs the first CPLD 413 to generate and/or transmit one or more commands that power off the main power supply for one or more computing nodes. The one or more computing nodes to be powered off may be selected based on a first set of factors (e.g., no computational task currently running at the computing node that is to be powered off).

In some embodiments, in response to detecting the first triggering event that indicates that a computing load of the computing system 400 is low, the controller 405 may determine the total number of computing nodes to be powered off, e.g., based on the computing load. Additionally, or alternatively, the controller 405 may select one or more computing nodes to be powered off, and/or determine the time the selected one or more computing nodes to be powered off.

As a non-limiting example, the controller 405 may select to turn off the fourth computing node 404 from the second, third, and fourth computing nodes. The controller 405 may, or may not, select the fourth computing node 404 based on a first set of factors or conditions (e.g., the fourth computing node not running any computational task, while both the second and third computing nodes are running tasks) when the first triggering event 481 is detected. In this non-limiting example, the controller 405 may transmit the first message to the first CPLD 413, where the first message instructs the first CPLD 413 to generate and/or transmit a first command that causes the fourth main power supply 445 for the fourth computing node 404 to be turned off.

Continuing with the non-limiting example above, in response to receiving the first message from the controller 405, the first CPLD 413 for the first computing node 401 may transmit the first command to the fourth CPLD 443. In response to receiving the first command from the first CPLD 413, the fourth CPLD 443 may control the fourth main power supply 445 to be turned/powered off. In response to determining that the fourth main power supply 445 has been turned off, the fourth CPLD 443 may transmit a first notification to the controller 405 (e.g., directly, or indirectly via the first CPLD 413), where the first notification notifies the controller 405 that the fourth main power supply 445 has been turned off. In response to receiving the first notification from the fourth CPLD 443, the controller 405 may control the fourth standby power supply 447 to be powered off. In this way, the fourth main power supply 445 and the fourth standby power supply 447 for the fourth computing node 404 are both turned off. The power consumption of the computing system 400 is therefore reduced as much as possible, without affecting the computational performance of the computing system 400.

It is noted that, in the non-limiting example above, the controller 405 may select the second computing node 402, the third computing node 403, and the fourth computing node 404 to be turned off (e.g., when the overall utilization rate of processors of the computing system 400 is by way of example approximately 10%) when the first triggering event 481 is detected. In some embodiments, prior to powering off a corresponding main power supply (and/or a corresponding standby power supply) for each of the second, third, and fourth computing nodes (e.g., 402, 403, and 404), task(s) (if any) assigned or allocated to each of the second, third, and fourth computing nodes may be re-assigned or re-allocated to other computing node (e.g., the first computing node 401). After the task(s) from the second, third, and fourth computing nodes (e.g., 402, 403, 404) are re-assigned or re-allocated to the first computing node 401, an utilization rate of processor(s) of the first computing node (e.g., 401) may increase to be, e.g., approximately 10%, which may be still lower than the first processor utilization rate threshold (e.g., 20%). It is noted that, the main power supply and standby power supply for each of the second, third, and fourth computing nodes may be turned off in the same or similar way as described above, which reduces the power consumption for each of the second, third, and fourth computing nodes (e.g., to approximately zero if the standby power supply for each computing node is powered off). The specific process of turning off the main power supply and/or standby power supply for each of the second, third, and fourth computing nodes may be found similar to descriptions above, and repeated descriptions are omitted herein for the sake of brevity.

In some embodiments, the controller 405 may be configured to detect a second triggering event that triggers one or more computing nodes to be powered on. For example, the second triggering event may be an event at which the utilization rate of a single processor (e.g., the first CPU 411 of the first computing node 401 or other applicable processor) is determined to be beyond a second processor utilization rate threshold (e.g., 80%) for a first duration (e.g., 5 min) and/or at which the utilization rate of a single memory (e.g., the first memory 419 of the first computing node 401 or other applicable memory) is determined to be beyond a second memory utilization rate threshold (e.g., 90%) for a second duration (e.g., 5 min).

As another example, the second triggering event may be an event at which the total utilization rate of one or more processor (e.g., all processors) of the computing system 400 is determined to be beyond the second processor utilization rate threshold (e.g., 80%) for the first duration (e.g., 5 min) and/or at which the total utilization rate of one or more memories (e.g., all memories) of the computing system 400 is determined to be beyond the second memory utilization rate threshold (e.g., 90%) for the second duration (e.g., 5 min).

As a further example, the second triggering event may be an event at which the utilization rate of each processor of one or more processor (e.g., all processors) of the computing system 400 is determined to be beyond the second processor utilization rate threshold (e.g., 80%) for the first duration (e.g., 5 min) and/or at which the utilization rate of each memory of one or more memories (e.g., all memories) of the computing system 400 is determined to be beyond the second memory utilization rate threshold (e.g., 90%) for the second duration (e.g., 5 min).

The detection of the second triggering event 491 may cause a second set of actions that powers on one or more computing nodes to be performed. For example, in response to detecting the second triggering event that indicates that a computing load of the computing system 400 is high (e.g., the utilization rate of the first CPU 411 and/or any other active processor is greater than 80% for at least 5 min and/or the utilization rate of the first memory 419 and/or other memory is greater than 90% for at least 5 min), the controller 405 may determine the total number of computing nodes to be turned on. In some embodiments, the controller 405 may select to turn on one or more computing nodes based on a second set of factors. The second set of factors may include, for example, a current operating status of a corresponding computing node, a type of computational task (e.g., training stage for a machine learning (ML) model vs. inference stage for ML model) being performed (or to be performed), a power consumption performance of the corresponding computing node, memory bandwidth of the corresponding computing node, and/or a computational capability of the corresponding computing node.

For instance, the controller 405 may select to turn on both the second computing node 402 and the fourth computing node 404 to share computational load with the first computing node 401 in response to detecting the second triggering event (which indicates a high computing load of the computing system 400). In this case, the controller 405 may control the second standby power supply 427 and the fourth standby power supply 447 to be turned on, respectively.

In response to determining that the second standby power supply 427 has been turned on, the controller 405 may generate and/or transmit, to the first CPLD 413, a message that instructs the first CPLD 413 to transmit a command (to turn on the second main power supply 425) to the fourth CPLD 443. The command (to turn on the second main power supply 425) may be applied to turn on the second main power supply 425 for the second computing node 402. In response to receiving the such message from the controller 405, the second CPLD 423 may control the second main power supply 425, to turn on the second main power supply 425, which may supply power to one or more processors (not shown in FIG. 4) of the second computing node 402.

In response to determining that the fourth standby power supply 447 has been turned on, the controller 405 may generate and/or transmit a message to the first CPLD 413, where the message instructs the first CPLD 413 to transmit a command (to turn on the fourth main power supply 445) to the fourth CPLD 443. In response to receiving the message from the controller 405, the fourth CPLD 443 may control the fourth main power supply 445, to turn on the fourth main power supply 445, which may supply power to one or more processors of the fourth computing node 404. Accordingly, the computational capabilities of the fourth computing system 400 is increased by turning on the main power supplies that supply power to processor(s) of one or more computing nodes (e.g., the second and fourth computing nodes) of the computing system 400.

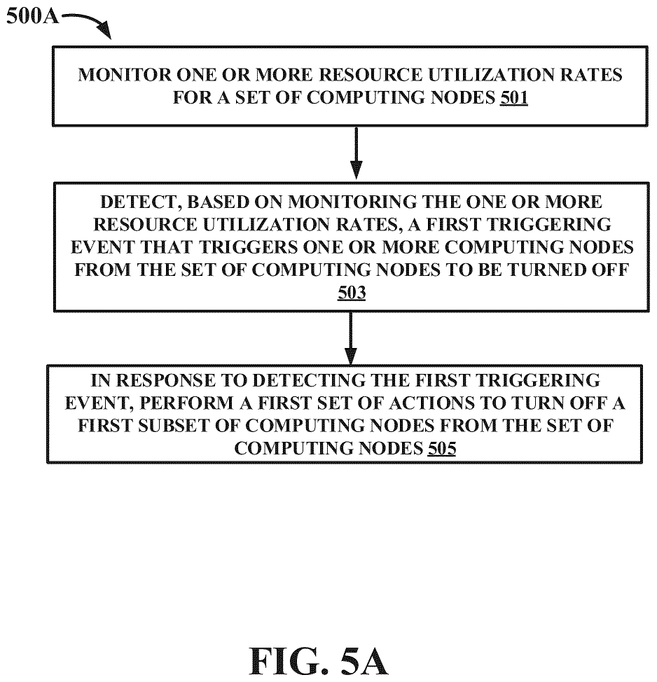

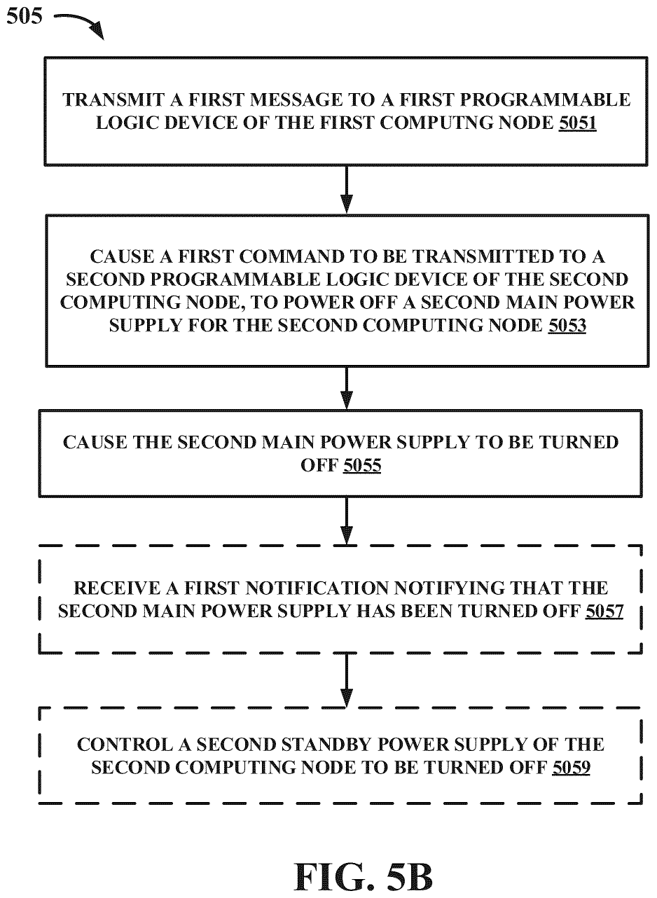

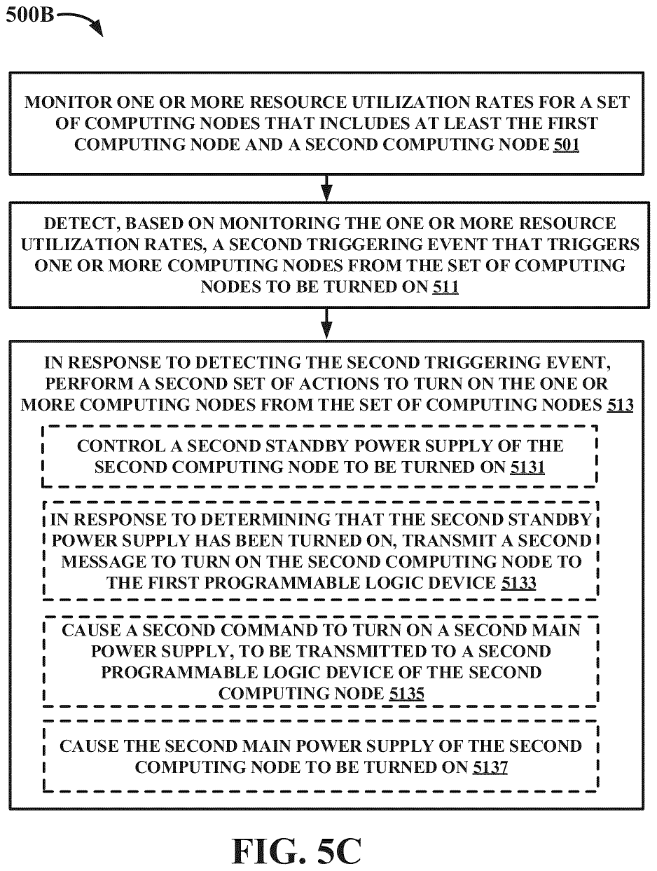

FIG. 5A and FIG. 5B illustrate a method 500A for controlling power supply of a server device (e.g., “200” in FIG. 2, or other computing system such as “300” in FIG. 3A or “400” in FIG. 4), according to one or more embodiments of the present disclosure. FIG. 5C illustrates a method 500B for controlling power supply of a server device (or other computing system), according to one or more embodiments of the present disclosure. A system for performing the method 500A and/or 500B to control power supply of a server device (or other computing device) can include a controller (e.g., BMC), memory (e.g., register), and/or other components (e.g., programmable logic device). While operations of the method 500A or 500B are shown in a particular order, this is not meant to be limiting. One or more operations may be reordered, omitted, and/or added except where otherwise apparent from context.

In various embodiments, as shown in FIG. 5A, at stage 501, the system may at least monitor one or more resource utilization rates for a first computing node (e.g., “301” in FIG. 3A, or “451” in FIG. 4), where the first computing node is from a set of computing nodes that include at least the first computing node and a second computing node (e.g., “302” in FIG. 3A, or “452” in FIG. 4). The set of computing nodes may be accommodated in a housing (e.g., chassis “250” in FIG. 2) of the server device (or other computing device). In some embodiments, the system may monitor one or more resource utilization rates for the second computing node as well. For example, the system (e.g., via a controller, see “405” in FIG. 4, or “305” in FIG. 3A) may monitor a utilization rate of each processor within the first computing node, a utilization rate of each processor within the second computing node, a utilization rate of each memory within the first computing node, and a utilization rate of each memory within the second computing node.

Additionally, or alternatively, the system may monitor a total utilization rate of processors for each computing node, and/or a total utilization rate of memories for each computing node. Additionally, or alternatively, the system (e.g., controller) may monitor a total utilization rate of one or more processors (e.g., all processors) of the computing system (e.g., a server), and/or a total utilization rate of one or more memories (e.g., all memories) of the computing system (e.g., a server).

It is noted that, the set of computing nodes may, or may not, include one or more additional computing nodes. For instance, the set of computing nodes may include a third computing node (e.g., “453” in FIG. 4) and/or a fourth computing node (e.g., “454” in FIG. 4). In this case, the system may monitor one or more resource utilization rates for the third and/or fourth computing nodes as well. For example, the system may monitor whether and how much any processor of the third and/or fourth computing nodes is being utilized.

In some embodiments, the first computing node is disposed on a first circuit board (e.g., a first motherboard, see “303” in FIG. 3A), and the second computing node is disposed on a second circuit board (e.g., a second motherboard, see “304” in FIG. 3A) separate from the first circuit board. For example, the first circuit board may be disposed above or below the second circuit board. As another example, the first circuit board may be adjacent to the second circuit board. The relative positions of the first and second circuit boards are not limited to description herein. In some embodiments, the first circuit board and the second circuit board may be connected to, e.g., a midplane as described previously. In this case, component(s) of the first computing node may be in communication with component(s) of the second computing node wirelessly, or through wires organized using the midplane. In other embodiments, a plurality of computing nodes (e.g., first and second computing nodes) may be a single circuit board.

In some embodiments, the server device may include a controller (e.g., BMC, such as “305” in FIG. 3A, or “405” in FIG. 4). The controller may be coupled to, attached to, or in proximity with, the first circuit board (e.g., “303” in FIG. 3A, or “451” in FIG. 4). For example, the controller may be disposed on a datacenter-ready secure control module (DC-SCM) board, where the DC-SCM (e.g., “306” in FIG. 3A) is attached to the first circuit board.

In some embodiments, the first computing node may include a first processor (e.g., “311A” in FIG. 3A) and/or a first memory (e.g., “317” in FIG. 3A). In this case, the one or more resource utilization rates for the first computing node may include: an utilization rate of the first processor, and/or an utilization rate of the first memory. In some embodiments, the second computing node may include a second processor and/or a second memory. In this case, the one or more resource utilization rates for the second computing node may include: an utilization rate of the second processor, and/or an utilization rate of the second memory.

In some embodiments, the first computing node may include a first programmable logic device (e.g., first CPLD, see “313” in FIG. 3A) that is connected, respectively, to the controller and a second programmable logic device (e.g., “323” in FIG. 3A) from the second computing node. In some embodiments, the first programmable logic device may be connected to the controller via a set of communication links that includes a communication link (e.g., I2C) with a first data transmission rate and a communication link (e.g., UART) with a second data transmission rate, where the first data transmission rate is different from the second data transmission rate. The second programmable logic device may be, for instance, a second CPLD. In some embodiments, the second programmable logic device may be connected to the controller. The first programmable logic device of the first computing node may be configured to control the second programmable logic device of the second computing node (e.g., via an LVDS interface).

In some embodiments, the first computing node may include a first set of power supplies (e.g., a first main power supply and/or a first standby power supply). The first main power supply (e.g., “315A” in FIG. 3A) may be applied to supply power (e.g., 12 volts and 48 volts) to the first processor (e.g., “311A” and/or “311B” in FIG. 3A, which may be or may include CPU(s), GPU(s), or other applicable type of processor(s)), and/or one or more cooling units of the first computing node. The first standby power supply (e.g., “315B” in FIG. 3A) may be applied to supply power (e.g., 3.3 volts and 1.8 volts) to other components (e.g., first memory, and first CPLD) of the first computing node that enable essential functions of the first computing node. The second computing node may include a second set of power supplies (e.g., a second main power supply and/or a second standby power supply). The second main power supply (e.g., “325A” in FIG. 3A) may be applied to supply power to the second processor (e.g., “321A” and/or “321B” in FIG. 3A, which may be or may include CPU(s), GPU(s), or other applicable type of processor(s)), and/or one or more cooling units of the second computing node. The second standby power supply (e.g., “325B” in FIG. 3A) may be applied to supply power to other components (e.g., second memory and/or the second programmable logic device) of the second computing node that enable essential functions of the second computing node.

The first programmable logic device (e.g., first CPLD, see “313” in FIG. 3A) of the first computing node may be connected to the first main power supply (e.g., to control the on and/or off of the first main power supply), and the controller may be connected to the first standby power supply of the first computing node. The second programmable logic device of the second computing node may be connected to the second main power supply (e.g., to control the on and off of the second main power supply which may supply power to the second processor), and the controller may be connected to the second standby power supply of the second computing node.

That is, the controller may be connected to the first standby power supply of the first computing node and the second standby power supply of the second computing node, respectively. As a result, the controller may be configured to control the first standby power supply, e.g., to turn on or turn off the first standby power supply. Additionally, or alternatively, the controller may be configured to control the second standby power supply, e.g., to turn on or turn off the second standby power supply.

In various embodiments, as shown in FIG. 5A, at stage 503, the system may detect, based on monitoring the one or more resource utilization rates for the first computing node, a first triggering event that triggers one or more computing nodes from the set of computing nodes to be turned off. For example, the system (e.g., via the controller) may determine that the first triggering event occurs in response to determining that the utilization rate (e.g., a total utilization rate) of one or more processors (e.g., all processors, including 311A, 311B, 321A and 321B in FIG. 3A) of the computing system is below a first processor utilization rate threshold (e.g., 20%) for a first time period (e.g., 5 min) and in response to determining that the utilization rate (e.g., a total utilization rate) of one or more memories (e.g., all memories, including 317 and 327 in FIG. 3A) of the computing system is below a first memory utilization rate threshold (e.g., 30%) for a second time period (e.g., 5 min). The occurrence of the first triggering event may indicate that the computational tasks currently running using the computing system is light (e.g., below a computational threshold), and therefore one or more computing nodes from the set of computing nodes may be powered off to save energy and power consumption.

In various embodiments, as shown in FIG. 5A, at stage 505, the system may, in response to detecting the first triggering event, perform a first set of actions to turn off a first subset of computing nodes from the set of computing nodes. For example, the set of computing nodes may include the first and second computing nodes. In this example, in response to detecting the first triggering event, the system may perform the first set of actions to turn off the second computing node. As another example, the set of computing nodes may include the first computing node, the second computing node, and the third computing node. In this case, in response to detecting the first triggering event, the system may perform the first set of actions to turn off the second and third computing nodes.

In the example above where the second computing node is to be turned off, as shown in FIG. 5B, the first set of actions may include a first action 5051 where the controller transmits a first message (e.g., “352” in FIG. 3C) to the first programmable logic device (e.g., on the first circuit board) of the first computing node. The first message may include content that enables the first programmable logic device to transmit a first command (e.g., “353” in FIG. 3C) to the second programmable logic device to power off the second main power supply for the second computing node. The first set of actions to turn off the second computing node may further include a second action 5053 where, in response to receiving the first message, the first programmable logic device transmit the first command to the second programmable logic device to power off the second main power supply for the second computing node. In other words, transmitting the first message to the first programmable logic device causes the first command to be transmitted to the second programmable logic device.

In some embodiments, prior to having the first command transmitted to the second programmable logic device, tasks (and associated data) performed using the second computing node may be allocated or re-allocated to one or more other computing nodes (e.g., the first computing node), such that when the second main power supply is turned off, the tasks may be performed and associated data may be retained. In some embodiments, the first set of actions to turn off the second computing node may further include a third action 5055 where, in response to receiving the first command to power off the second main power supply, the second programmable logic device controls/causes the second main power supply to be turned off.

As mentioned previously, the second main power supply may be configured to supply power (e.g., 12 volts) to the second processor (which may be a CPU, GPU, or other applicable type of processor), to other processor(s) of the second computing node (if any), and/or to one or more cooling units of the second computing node. In this case, turning off the second main power supply will power off the second processor, other processor(s) of the second computing node (if any), and/or the one or more cooling units of the second computing node, which often consume a relatively high amount of energy and power. Accordingly, the total power consumption of the server device (or any other applicable system or device having the first and second computing nodes) can be reduced.

In some embodiments, the first set of actions may further include a fourth action 5057 where the controller receives a first notification (e.g., “354” in FIG. 3C), directly or indirectly, from the second programmable logic device, where the first notification notifies the controller that the second main power supply has been turned off. In some embodiments, the first set of actions may further include a fifth action 5059 where, in response to receiving the first notification that notifies that the second main power supply is turned off, the controller controls the second standby power supply of the second computing node to be turned off. In this way, both the second main power supply and the second standby power supply, of the second computing node, are turned off. Accordingly, the power consumption of the second computing node may be reduced to approximately zero. Accordingly, overall power consumption of the computing system (e.g., a server device) is reduced.

In the example above where both the second and third computing nodes are to be turned off, the first set of actions may include a sequence of actions to turn off the second computing node (as described above) and a sequence of actions to turn off the third computing node. The sequence of the actions to turn off the second computing node and the sequence to turn off the third computing node may be performed at the same time, or at different times. The sequence of actions to turn off the third computing node may be similar to the sequence of actions to turn off the second computing node, and repeated descriptions are omitted herein.

In various embodiments, referring to FIG. 5C, additionally, or alternatively, at stage 511, the system may detect, based on monitoring the aforementioned one or more resource utilization rates, a second triggering event that triggers one or more computing nodes from the set of computing nodes to be turned on. For example, the system may determine that the second triggering event occurs in response to determining that the utilization rate (e.g., total utilization rate) of one or more processors (e.g., all processors, or each processor) of the computing system is beyond a second processor utilization rate threshold (e.g., 80%) for a first duration (e.g., 5 min) and in response to determining that the utilization rate (e.g., total utilization rate) of one or more memories (e.g., all memories, or each memory) of the computing system is beyond a second memory utilization rate threshold (e.g., 90%) for a second time period (e.g., 5 min). The occurrence of the second triggering event may indicate that additional computing node(s) are needed to enhance the computational efficiency of the computing system (e.g., server device), and therefore other computing node(s) from the set of computing nodes need to be powered on.

In various embodiments, as shown in FIG. 5C, at stage 513, the system may, in response to detecting the second triggering event, perform a second set of actions to turn on a second subset of computing nodes from the set of computing nodes. For example, the set of computing nodes may include the first and second computing nodes. In this example, in response to detecting the second triggering event and in response to determining that the second computing node is powered off, the system may perform the second set of actions to turn on the second computing node.

In the example above, the second set of actions to turn on the second computing node may include an action 5131 where the controller controls the second standby power supply of the second computing node to be turned on. The second set of actions may further include an action 5133 where, in response to determining that the second standby power supply has been turned on, the controller transmits a second message (e.g., “362” in FIG. 3D) to the first programmable logic device, where the second message instructs the first programmable logic device to transmit a second command (e.g., “363” in FIG. 3D) that powers on the second main power supply for the second computing node. The second set of actions may further include an action 5135 where, in response to receiving the second message from the controller, the first programmable logic device transmits the second command to the second programmable logic device. The second set of actions may further include an action 5137 where, in response to receiving the second command from the first programmable logic device, the second programmable logic device controls the second main power supply of the second computing node to turn on the second main power supply. Accordingly, processor(s) of the second computing node to which the second main power supply supplies power may be powered on, and the computational capabilities of the server device may be therefore increased.

As another example, the set of computing nodes may include the first computing node, the second computing node, and the third computing node. In this example, the first set of actions may include an action where the system selects to turn on one or more computing nodes from the second and third computing nodes. In some embodiments, the system may select to turn on the one or more computing nodes from the second and third computing nodes based on a second set of factors (e.g., whether the second and/or third computing nodes are powered off, a computational capability of the second and/or third computing node, memory bandwidths of the second and/or third computing nodes, power consumption of the second and/or third computing nodes, etc.). For instance, the system may select to turn on the third computing node, e.g., based on the third computing node possessing stronger computational capability than the second computing node while consuming less power than the second computing node. In this case, the second set of actions may include a sequence of actions to turn on the third computing node. The sequence of the actions to turn on the third computing node may be similar to the second set of actions described in FIG. 5C, and repeated descriptions are omitted herein.

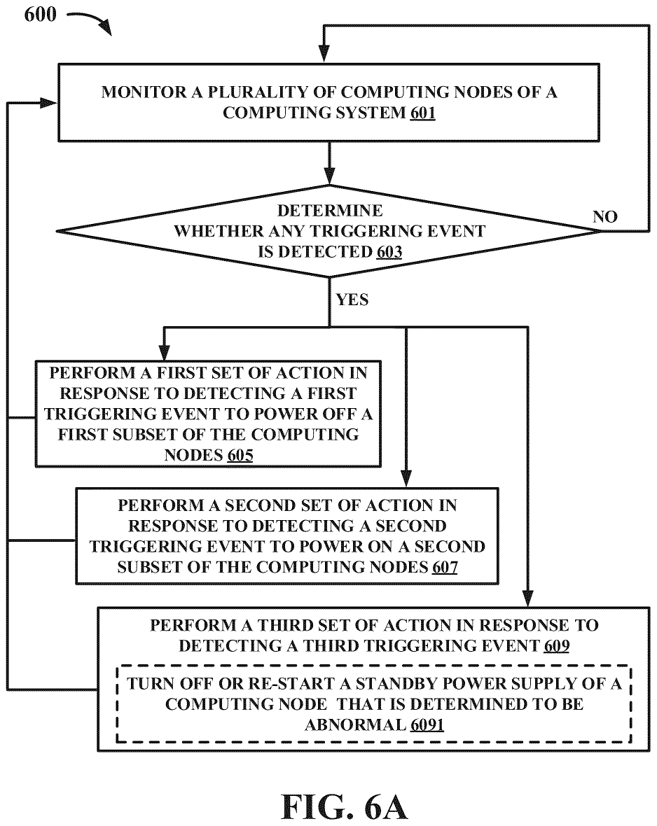

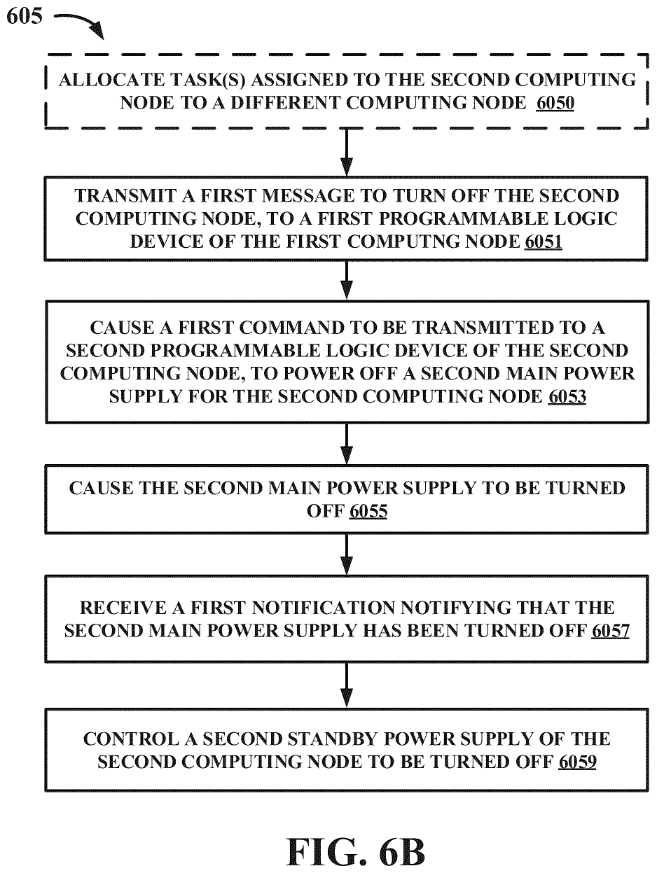

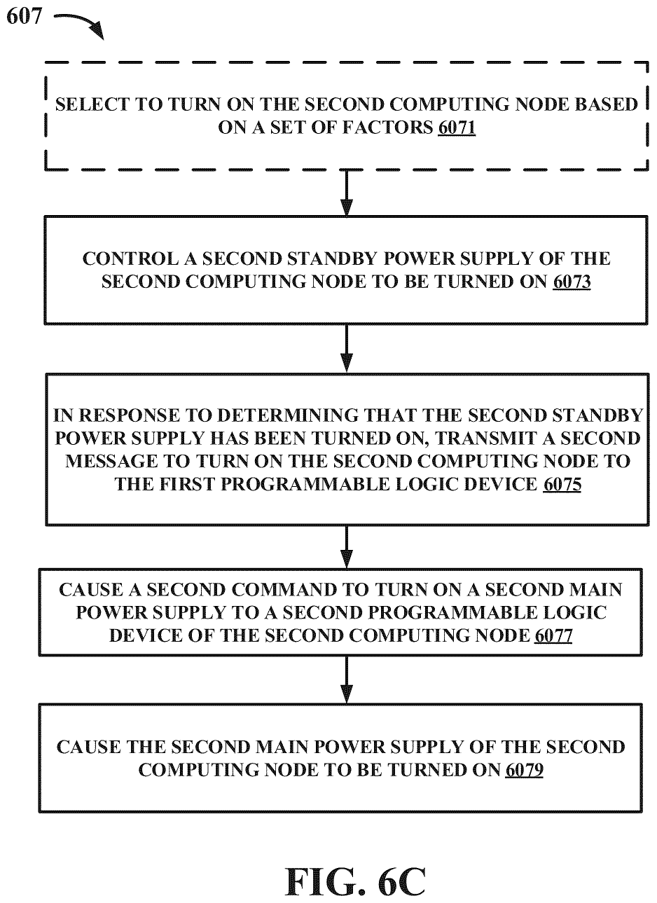

FIGS. 6A, 6B, and 6C illustrates a method 600 for controlling power supply of a server device (e.g., “200” in FIG. 2, or other computing system such as “300” in FIG. 3A or “400” in FIG. 4), according to one or more embodiments of the present disclosure. A system for performing the method 600 can include a controller, memory, and/or other components such as programmable logic device(s). While operations of the method 600 are shown in a particular order, this is not meant to be limiting. One or more operations may be reordered, omitted, and/or added.

In various embodiments, as shown in FIG. 6A, at stage 601, the system may monitor a plurality of computing nodes of a server device (or other computing system). The server device may include at least a first computing node (e.g., “401” in FIG. 4) and a second computing node (e.g., “402” in FIG. 4). The first computing node may be disposed on a first circuit board (e.g., “451” in FIG. 4), and the second computing node may be disposed on a second circuit board (e.g., “452” in FIG. 4) different from the first circuit board. The server device may further include a controller (e.g., “405” in FIG. 4) attached to the first circuit board. For example, the controller (e.g., BMC) may be disposed on a datacenter-ready secure control module (DC-SCM) board (e.g., “465” in FIG. 4) that is attached to the first circuit board. It is noted that, while the plurality of computing nodes may, or may not, include one or more additional computing nodes. For instance, the plurality of computing nodes may include a third computing node (e.g., “403” in FIG. 4), a fourth computing node (e.g., “404” in FIG. 4), etc.

In some embodiments, the first computing node may include a first processor (e.g., “411” in FIG. 4), a first programmable logic device (e.g., CPLD or FPGA, see “413” in FIG. 4), and a first memory (e.g., “419” in FIG. 4). The first computing node may further include one or more power supplies that supply power to the first computing node. The second computing node may include a second programmable logic device (e.g., CPLD or FPGA, see “423” in FIG. 4) and a second set of power supplies (e.g., a first power supply and/or a second power supply). The second computing node may further include one or more processors and one or more memory devices.

The first power supply (e.g., “425” in FIG. 4) of the second computing node may be (or may include) a main power supply. The second power supply (e.g., “427” in FIG. 4) of the second computing node may be (or may include) a standby power supply. The first power supply may be configured to provide a first set of voltages, and the second power supply may be configured to provide a second set of voltages. In some embodiments, the first set of voltages (e.g., 12 volts and 5 volts) may be greater than or equal to the second set of voltages (e.g., 5 volts, 3.3 volts, 1.8 volts). In some embodiments, the main power supply of the second computing node may be configured to supply power to the one or more processors of the second computing node and/or other components such as cooling unit(s) of the second computing node. The standby power supply of the second computing node may be configured to supply power to other components (e.g., the second programmable logic device and/or the one or more memory devices of the second computing device).

In some embodiments, the second programmable logic device of the second computing node may be configured to control the first power supply (e.g., the main power supply) of the second computing node. The controller (e.g., BMC) may be configured to control the second power supply (e.g., the standby power supply) of the second computing node. In some embodiments, the controller may be in communication with (e.g., be directly connected to) the first and second programmable logic devices. For example, the controller may be directly connected to the first (and/or second) programmable logic device via one or more communication links (e.g., I2C and/or UART).

In various embodiments, at stage 603, the system determines, based on monitoring the plurality of computing nodes, whether any triggering event is detected. For example, the system may monitor the plurality of computing nodes to determine whether a first triggering event to power off a first subset of the computing nodes (e.g., the second computing node) is detected. Additionally, or alternatively, the system may monitor the plurality of computing nodes to determine whether a second triggering event to power on a second subset of the computing nodes (e.g., the second computing node) is detected. Additionally, or alternatively, the system may monitor the plurality of computing nodes to determine whether a third triggering event is detected, where the third triggering event occurs when a programmable logic device of any of the plurality of computing nodes becomes abnormal. Descriptions of the first, second, and third triggering event may be found elsewhere of this present disclosure, and repeated descriptions are omitted herein.

In various embodiments, as shown in FIG. 6A, at stage 605, the system may perform a first set of action in response to detecting the first triggering event to power off a first subset of the computing nodes. In some embodiments, the first triggering event occurs when the controller determines that the utilization rate of each processor of a server device (or other computing system) is below a first processor utilization rate threshold (e.g., 20%) for a first time period (e.g., 5 min) and that the utilization rate of each memory of a server device (or other computing system) is below a first memory utilization rate threshold (e.g., 30%) for a second time period (e.g., 5 min). In this case, referring to FIG. 6B, the system may perform, at stage 6051, a first action where the controller transmits a first message (e.g., “352” in FIG. 3C) to the first programmable logic device. The first message may include content that enables the first programmable logic device to transmit a first command (e.g., “353” in FIG. 3C) to the second programmable logic device to power off the first power supply (e.g., the second main power supply “325A” in FIG. 3C) for the second computing node.

The system may perform, at stage 6053, a second action where, in response to receiving the first message, the first programmable logic device transmits the first command to the second programmable logic device to power off the first power supply (e.g., main power supply that supplies power, at voltage levels such as 12V and/or 48V, to processor(s)) for the second computing node. The system may perform, at stage 6055, a third action where, in response to receiving the first command to power off the first power supply, the second programmable logic device controls the first power supply of the second computing node to be turned off. The system may perform, at stage 6057, a fourth action where the controller receives a first notification (e.g., “354” in FIG. 3C), directly or indirectly, from the second programmable logic device. The first notification may notify that the first power supply of the second computing node has been turned off. The system may perform, at stage 6059, a fifth action where, in response to receiving the first notification that notifies that the first power supply of the second computing node has been turned off, the controller controls the second power supply (e.g., the second standby power supply “325B” in FIG. 3C) of the second computing node to be turned off.

Accordingly, both the first power supply and the second power supply, of the second computing node, are turned off. Accordingly, the power consumption of the second computing node may be reduced to approximately zero. Accordingly, overall power consumption of the service device is reduced.

It is noted that, in some embodiments, prior to transmitting the first message to the first programmable logic device (at stage 6051), the system may further, at stage 6050, allocate tasks (or traffic) assigned to (or routed towards) the second computing node to a different computing node. This way, when the first power supply of the second computing node is turned off, the tasks assigned to processor(s) of the second computing node may still be reserved and may be performed using other computing node(s) (e.g., the first computing node).

In various embodiments, referring to FIG. 6A, at stage 607, the system may perform a second set of action in response to detecting the second triggering event to power on a second subset of the computing nodes. In some embodiments, the second triggering event occurs when the controller determines that the utilization rate of each active processor of the server device (or other computing system) is beyond (e.g., greater than) a second processor utilization rate threshold (e.g., 80%) for a first duration (e.g., 5 min) and that the utilization rate of each memory of the server device (or other computing system) is beyond a second memory utilization rate threshold (e.g., 90%) for a second time period (e.g., 5 min). In this case, as shown in FIG. 6C, the system may perform, at stage 6073, an action where the controller controls the second power supply (e.g., the second standby power supply “325B” in FIG. 3C) of the second computing node to be turned on.

The system may further perform, at stage 6075, an action where, in response to determining that the second power supply has been turned on, the controller transmits a second message (e.g., “362” in FIG. 3D) to the first programmable logic device, where the second message instructs the first programmable logic device to transmit a second command (e.g., “363” in FIG. 3D) that powers on the first power supply for the second computing node. The system may perform, at stage 6077, an action where, in response to receiving the second message from the controller, the first programmable logic device transmits the second command to the second programmable logic device. The system may perform, at stage 6077, an action where, in response to receiving the second command from the first programmable logic device, the second programmable logic device controls the first power supply (e.g., the second main power supply “325A” in FIG. 3C) of the second computing node to be turned on. In this way, processor(s) of the second computing node may receive power supply from the first power supply (e.g., the main power supply), and the computational capabilities of the server device is therefore increased.

It is noted that, in some embodiments, prior to controlling the second power supply (e.g., standby power supply) of the second computing node to be turned on (at stage 6073), the system may further, at stage 6071, select to turn on the second computing node based on a second set of factors (e.g., the second computing node is powered off, the memory bandwidth of the second computing node, the type and/or total number of processors that are included in the second computing node, etc.).

In various embodiments, as shown in FIG. 6A, at stage 609, the system may perform a third set of action in response to detecting the third triggering event that triggers one or more remedial actions. In some embodiments, the third triggering event occurs when the controller determines that a programmable logic device within the server device is abnormal. The programmable logic device may be the first programmable logic device of the first computing node, or the second programmable logic device of the second computing node. For example, the second programmable logic device may be detected to be abnormal. In this case, as shown in FIG. 6A, the third set of actions may include an action 6091 where the controller turns off or reset the second power supply (e.g., the “second standby power supply” in FIG. 3B), where the second power supply supplies power to the second programmable logic device (which is detected to be abnormal).

In some embodiments, after the second power supply is turned off, the second programmable logic device may be detached for maintenance, or may be replaced. This is because turning off the second power supply (which supplies power to the second programmable logic device) causes the second programmable logic device to stop operation, resulting in the first power supply to be turned off given that the second programmable logic device controls on-and-off of the first power supply. In other words, turning off the second power supply may cause the first power supply to be turned off as well, and therefore the second computing node may be powered off (e.g., completely). In some embodiments, after the second power supply is reset, whether the second programmable logic device is abnormal is determined, and if the second programmable logic device is still abnormal after the second power supply is reset, the controller may turn off the second power supply that supplies power to the second programmable logic device of the second computing node, such that the second programmable logic device can be replaced or maintained.

As another example, the first programmable logic device (e.g., CPLD 413 in FIG. 4) may be detected to be abnormal. In this case, the third set of actions may include an action where the controller turns off or reset a first standby power supply (e.g., “417” in FIG. 4). Additionally, or alternatively, the third set of actions may include an action where the controller is configured to control programmable logic device(s) (e.g., second programmable logic device “323” previously controlled by the controller via the first programmable logic device), using communication links therebetween (e.g., 374a and/or 374b in FIG. 3A).

The controller may turn off the first standby power supply, which supplies power to the first programmable logic device (e.g., “413” in FIG. 4). As a result, the first logic device may stop operation, resulting in the first main power supply (e.g., “415” in FIG. 4) that supplies power to the first processor (e.g., “411”) to be turned off. After the first main power supply is turned off, the first programmable logic device may be replaced or detached for maintenance. Alternatively, the controller may reset the first standby power supply, which supplies power to the first logic device (e.g., “413” in FIG. 4). As a result, whether the first logic device can be re-started is determined. In response to determining that the first programmable logic device is re-started, whether the first processor (that receives power supply from the first main power supply) operates may be determined. In response to determining that the first processor starts running, the first programmable logic device may not need to be detached for replacement or maintenance. Otherwise, in response to determining that the first programming logic device is not re-started (or the first processor is not running after the first programming logic device is re-started), the first programming logic device may be detached for maintenance or replacement.

In some embodiments, as shown in FIG. 6A, the system may continue monitoring the plurality of the computing nodes, e.g., in response to not detecting any triggering event (e.g., none of the first, second, and third triggering events).

By using the disclosed method(s) and system(s), the overall power consumption of a server device (or other computing system) may be dynamically and automatically adjusted (e.g., reduced when the computational task is relatively light) and sufficient computational capabilities of the server device may be constantly ensured (e.g., when the computational task is relatively high).

In some embodiments, the system can update firmware of the one or more programmable logic devices (and/or other components) of the system, to manage the system and to ensure normal operation of the one or more programmable logic devices within the system. For example, the system can update the firmware of the one or more programmable logic devices regularly or as desired. The system can, additionally, or alternatively, manage the system via other actions described elsewhere of the specification, and repeated descriptions are omitted herein.

In various embodiments, a system is provided. The system may include: one or more processors. The one or more processors may include: a first group of processors coupled to a first circuit board, and a second group of processors coupled to a second circuit board. The second circuit board may be distinct from the first circuit board, or the second circuit board may be the same as the first circuit board. The system may further include: a controller, a first programmable logic device coupled to the first circuit board, a first power supply coupled to the second circuit board, a second power supply coupled to the second circuit board, and/or a second programmable logic device coupled to the second circuit board. The second programmable logic device may be configured to control the first power supply that is coupled to the second circuit board. The controller may be configured to control the second power supply that is coupled to the second circuit board.

In some embodiments, the first power supply may be configured to at least supply power to the second group of processors that is coupled to the second circuit board. In this case, the second programmable logic device may be configured to control the first power supply, thereby powering on (or powering off) the second group of processors. Additionally, or alternatively, the second power supply may be configured to at least supply power to the second programmable logic device that is coupled to the second circuit board. In this case, the controller may be configured to control the second power supply, thereby powering on (or powering off) the second programmable logic device.

In some embodiments, the first power supply may be further configured to supply power to one or more cooling units (e.g., fans, liquid cooling units) coupled to the second circuit board. Additionally, or alternatively, the second power supply may be configured to supply power to one or more memory devices (or memory cards) coupled to the second circuit board.

In some embodiments, the controller may be coupled to the first programmable logic device, to control the first programmable logic device, and the first programmable logic device may be further coupled to the second programmable logic device, to control the second programmable logic device.

In some embodiments, the controller may be further coupled to the second programmable logic device, and the controller may be configured to control the second programmable logic device, e.g., in response to detecting that the first programmable logic device is in an abnormal condition.

In some embodiments, the controller may be configured to monitor at least one processor from the one or more processors, to determine whether any triggering event is detected.

In some embodiments, the system may include one or more memories associated with the one or more processors. In some embodiments, the controller may be configured to determine that a first triggering event is detected based on: detecting that at least one utilization rate associated with the one or more processors is below a first processor utilization rate threshold for a first time period, or detecting that at least one utilization rate associated with the one or more memories is below a first memory utilization rate threshold for a second time period.

In some embodiments, the at least one utilization rate associated with the one or more processors include: an overall utilization rate of the one or more processors, a utilization rate of the first processor, or a utilization rate of the second processor. For example, the at least one utilization rate associated with the one or more processors may include the overall utilization rate of the one or more processors. As another example, the at least one utilization rate associated with the one or more processors may include a utilization rate of each of the one or more processors (including the first and second groups of processors). As a further example, the at least one utilization rate associated with the one or more processors may include a utilization rate of a single processor from the one or more processors. As a yet further example, the at least one utilization rate associated with the one or more processor may include a utilization rate of each processor from a subset of the one or more processors.

In some embodiments, in response to determining that the first triggering event is detected, the controller may be configured to: transmit a first message to power off the second circuit board, to the first programmable logic device. In some embodiments, transmitting the first message to the first programmable logic device causes the first programmable logic device to transmit a first command that powers off the first power supply, to the second programmable logic device. In some embodiments, transmitting the first command to the second programmable logic device causes the second programmable logic device to turn off the first power supply that is coupled to the second circuit board.

In some embodiments, the controller is further configured to: receive a first notification indicating that the first power supply has been turned off; and in response to receiving the first notification indicating that the first power supply has been turned off, control the second power supply to be turned off. The first notification may be received directly from the second programmable logic device. Additionally, or alternatively, the first notification may be received indirectly from the second programmable logic device via the first programmable logic device.

In some embodiments, prior to transmitting the first message to power off the second circuit board to the first programmable logic device, an operating system may be configured to allocate one or more tasks executable using the second group of processors to one or more additional processors that are not from the second group of processors.

In some embodiments, the controller is configured to determine that a second triggering event is detected based on: detecting that one or more utilization rates associated with the one or more processors is beyond a second processor utilization rate threshold for a first duration, or detecting that one or more utilization rates associated with the one or more memories is beyond a second memory utilization rate threshold for a second duration.

In some embodiments, in response to determining that the second triggering event is detected, the controller is configured to: control the second power supply, to turn on the second power supply, and transmit a second message to power on the second circuit board to the first programmable logic device. In some embodiments, transmitting the second message to the first programmable logic device causes the first programmable logic device to transmit a second command that powers on the first power supply, to the second programmable logic device. In some embodiments, transmitting the second command to the second programmable logic device causes the second programmable logic device to turn on the first power supply.

In some embodiments, the controller is configured to: determine that a third triggering event is detected based on: detecting that the first or second programmable logic device of the system is abnormal; and in response to determining that the third triggering event is detected, turn off or restart a standby power supply that supplies power to the first or second programmable logic device that is detected to be abnormal.

In some embodiments, the controller is further configured to: control the second programmable logic device to turn on or off the first power supply, in response to detecting that the first programmable logic device is in an abnormal condition.

In some embodiments, the controller is coupled, or in proximity, to the first circuit board.

In some embodiments, the system further include: a first main power supply coupled to the first circuit board; and a first standby power supply coupled to the first circuit board. The first main power supply may be controlled using the first programmable logic device, and the first standby power supply may be controlled using the controller.

In some embodiments, the one or more processors may further include: a third group of processors coupled to a third circuit board. The third circuit board may be distinct from the first circuit board and/or may be distinct from the second circuit board. In some embodiments, the system may further include: a third programmable logic device coupled to the third circuit board. The first programmable logic device may be further coupled to the third programmable logic device, to control the third programmable logic device.

In various embodiments, a method is provided for controlling power supply of a computing system (e.g., a distributed server system, a rack server having multiple nodes (e.g., computing nodes) within a chassis, etc.). The method may be performed, e.g., using a controller (e.g., BMC), where the controller may be coupled to the computing system or be included in the computing system. The computing system may include one or more memories, one or more processors, a first programmable logic device coupled to the first circuit board, a second programmable logic device coupled to the second circuit board, and/or a first power supply and a second power supply that are coupled to the second circuit board.

In some embodiments, the method may include: detecting a first triggering event to power off the second circuit board, where detecting the first triggering event may include: detecting that a utilization rate of the one or more processors is below a first processor utilization rate threshold for a first time period, or detecting that a utilization rate of the one or more memories is below a first memory utilization rate threshold for a second time period. The first triggering event may be an event that triggers automatic reduction of power consumption for the computing system. For example, the first triggering event may be an event that triggers at least one processor (or at least one computing node) of the computing system to be powered off. In response to detecting the first triggering event, the method may further include: transmitting a first message to power off the second circuit board to the first programmable logic device that is coupled to the first circuit board, where transmitting the first message to power off the second circuit board to the first programmable logic device causes the first programmable logic device to transmit a first command that powers off the first power supply, to the second programmable logic device that is coupled to the second circuit board, and where transmitting the first command to the second programmable logic device causes the second programmable logic device to turn off the first power supply that is coupled to the second circuit board.

In some embodiments, the method may further include: receiving a first notification notifying that the first power supply has been turned off; and in response to receiving the first notification notifying that the first power supply has been turned off, controlling the second power supply to be turned off.

In some embodiments, the method may further include: monitoring the first programmable logic device and the second programmable logic device; and in response to detecting that the first or second programmable logic device is abnormal, restarting or turning off a power supply that supplies power to the first programmable logic device, or the second programmable logic device, that is detected to be abnormal.

In various embodiments, another method for controlling power supply of a computing system (e.g., a server, a server system, etc.) is provided. The method may be performed using a controller (e.g., BMC) that is included in, or otherwise coupled to, the computing system. The computing system may include: one or more memories, one or more processors, a first programmable logic device coupled to the first circuit board, a second programmable logic device coupled to the second circuit board, and a first power supply and a second power supply that are coupled to the second circuit board.

In some embodiments, the method may include: detecting a second triggering event to power on the second circuit board. The second triggering event may be an event that triggers activation (or power on) of one or more additional processors of the computing system, to increase the computational capability of the computing system. The detecting the second triggering event may include: detecting that a utilization rate of the one or more processors is beyond a second processor utilization rate threshold for a first duration, or detecting that a utilization rate of the one or more memories is beyond a second memory utilization rate threshold for a second duration. In response to detecting the second triggering event, the method may further include: controlling the second power supply to turn on the second power supply that is coupled to the second circuit board; transmitting a message that powers on the second circuit board, to the first programmable logic device, where transmitting the message that powers on the second circuit board to the first programmable logic device causes the first programmable logic device to transmit a command that powers on the first power supply, to the second programmable logic device that is coupled to the second circuit board, and where transmitting the command to the second programmable logic device causes the second programmable logic device to turn on the first power supply that is coupled to the second circuit board.

In the present disclosure, the terms such as “coupled” and “connected” as used in this disclosure are broad terms that refer, without limitation, to one or more components being linked to another component(s), either directly or indirectly, in a wired or wireless manner that allows transmission of signals between the components. For example, components that are in communication with each other via a data bus may be referred to as being “coupled,” “electrically connected,” or “operably connected” to one another. As another example, one or more components that are connected to other component(s) through direct contact and/or a wired connection may be described as being “physically connected” to one another. Further, the terms “first,” “second,” “third,” and “fourth,” etc. may be used in the present disclosure to distinguish a component from another, without limiting the components, and regardless of their importance and/or order. The use of the terms “a” and “an” and “the” and “at least one” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Further, recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. It is understood that skilled artisans are able to employ such variations as appropriate, and the invention may be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system, comprising:
one or more processors comprising a first group of processors coupled to a first circuit board, and a second group of processors coupled to a second circuit board;
a first programmable logic device coupled to the first circuit board;
a first power supply coupled to the second circuit board;
a second power supply coupled to the second circuit board;
a second programmable logic device coupled to the second circuit board, the second programmable logic device being configured to control the first power supply that is coupled to the second circuit board; and
a controller configured to control the second power supply that is coupled to the second circuit board.

2. The system of claim 1, wherein:
the first power supply is configured to supply power to the second group of processors that is coupled to the second circuit board, and
the second power supply is configured to supply power to the second programmable logic device that is coupled to the second circuit board.

3. The system of claim 1, wherein:
the controller is coupled to the first programmable logic device, to control the first programmable logic device, and
the first programmable logic device is further coupled to the second programmable logic device, to control the second programmable logic device.

4. The system of claim 3, wherein the controller is further coupled to the second programmable logic device, and wherein the controller is configured to control the second programmable logic device in response to detecting that the first programmable logic device is in an abnormal condition.

5. The system of claim 1, wherein:
the controller is configured to determine that a first triggering event is detected based on:
detecting that at least one utilization rate associated with the one or more processors is below a first processor utilization rate threshold for a first time period, or
detecting that at least one utilization rate associated with one or more memories is below a first memory utilization rate threshold for a second time period, the one or more memories being associated with the one or more processors.

6. The system of claim 5, wherein the at least one utilization rate associated with the one or more processors comprises:
an overall utilization rate of the one or more processors,
a utilization rate of the first processor, or
a utilization rate of the second processor.

7. The system of claim 5, wherein:
in response to determining that the first triggering event is detected, the controller is configured to:
transmit a first message to power off the second circuit board, to the first programmable logic device,
wherein transmitting the first message to the first programmable logic device causes the first programmable logic device to transmit a first command that powers off the first power supply, to the second programmable logic device, and
wherein transmitting the first command to the second programmable logic device causes the second programmable logic device to turn off the first power supply that is coupled to the second circuit board.

8. The system of claim 7, wherein:
the controller is further configured to:
receive a first notification indicating that the first power supply has been turned off, the first notification being received directly from the second programmable logic device or indirectly from the second programmable logic device via the first programmable logic device, and
in response to receiving the first notification indicating that the first power supply has been turned off, control the second power supply to be turned off.

9. The system of claim 7, wherein prior to transmitting the first message to power off the second circuit board to the first programmable logic device, an operating system is configured to allocate one or more tasks executable using the second group of processors to one or more additional processors that are not from the second group of processors.

10. The system of claim 1, wherein:
the controller is configured to determine that a second triggering event is detected based on:
detecting that one or more utilization rates associated with the one or more processors is beyond a second processor utilization rate threshold for a first duration, or
detecting that one or more utilization rates associated with one or more memories is beyond a second memory utilization rate threshold for a second duration, the one or more memories being associated with the one or more processors.

11. The system of claim 10, wherein:
in response to determining that the second triggering event is detected, the controller is configured to:
control the second power supply, to turn on the second power supply, and
transmit a second message to power on the second circuit board to the first programmable logic device,
wherein transmitting the second message to the first programmable logic device causes the first programmable logic device to transmit a second command that powers on the first power supply, to the second programmable logic device, and
wherein transmitting the second command to the second programmable logic device causes the second programmable logic device to turn on the first power supply.

12. The system of claim 1, wherein the controller is configured to:
determine that a third triggering event is detected based on:
detecting that the first or second programmable logic device of the system is abnormal; and
in response to determining that the third triggering event is detected, turn off or restart a standby power supply that supplies power to the first or second programmable logic device that is detected to be abnormal.

13. The system of claim 12, wherein the controller is further configured to:
control the second programmable logic device to turn on or off the first power supply, in response to detecting that the first programmable logic device is in an abnormal condition.

14. The system of claim 1, wherein the controller is coupled, or in proximity, to the first circuit board.

15. The system of claim 1, further comprising:
a first main power supply coupled to the first circuit board; and
a first standby power supply coupled to the first circuit board,
wherein the first main power supply is controlled using the first programmable logic device, and
wherein the first standby power supply is controlled using the controller.

16. The system of claim 1, wherein:
the one or more processors further comprises a third group of processors coupled to a third circuit board, the third circuit board being distinct from the first circuit board and being distinct from the second circuit board,
a third programmable logic device is coupled to the third circuit board, and the first programmable logic device is further coupled to the third programmable logic device, to control the third programmable logic device.

17. A method for controlling power supply of a computing system that includes one or more memories, one or more processors, a first programmable logic device coupled to the first circuit board, a second programmable logic device coupled to the second circuit board, and a first power supply and a second power supply that are coupled to the second circuit board, the method comprising:
detecting a first triggering event to power off the second circuit board, comprising:
detecting that a utilization rate of the one or more processors is below a first processor utilization rate threshold for a first time period, or
detecting that a utilization rate of the one or more memories is below a first memory utilization rate threshold for a second time period; and
in response to detecting the first triggering event:
transmitting a first message to power off the second circuit board to the first programmable logic device that is coupled to the first circuit board,
wherein transmitting the first message to power off the second circuit board to the first programmable logic device causes the first programmable logic device to transmit a first command that powers off the first power supply, to the second programmable logic device that is coupled to the second circuit board, and
wherein transmitting the first command to the second programmable logic device causes the second programmable logic device to turn off the first power supply that is coupled to the second circuit board.

18. The method of claim 17, further comprising:
receiving a first notification notifying that the first power supply has been turned off, and
in response to receiving the first notification notifying that the first power supply has been turned off, controlling the second power supply to be turned off.

19. The method of claim 17, further comprising:
monitoring the first programmable logic device and the second programmable logic device, and
in response to detecting that the first or second programmable logic device is abnormal, restarting or turning off a power supply that supplies power to the first programmable logic device, or the second programmable logic device, that is detected to be abnormal.

20. A method for controlling power supply of a computing system that includes one or more memories, one or more processors, a first programmable logic device coupled to the first circuit board, a second programmable logic device coupled to the second circuit board, and a first power supply and a second power supply that are coupled to the second circuit board, the method comprising:
detecting a second triggering event to power on the second circuit board, comprising:
detecting that a utilization rate of the one or more processors is beyond a second processor utilization rate threshold for a first duration, or
detecting that a utilization rate of the one or more memories is beyond a second memory utilization rate threshold for a second duration; and
in response to detecting the second triggering event:
controlling the second power supply to turn on the second power supply that is coupled to the second circuit board;
transmitting a message that powers on the second circuit board, to the first programmable logic device;
wherein transmitting the message that powers on the second circuit board to the first programmable logic device causes the first programmable logic device to transmit a command that powers on the first power supply, to the second programmable logic device that is coupled to the second circuit board, and
wherein transmitting the command to the second programmable logic device causes the second programmable logic device to turn on the first power supply that is coupled to the second circuit board.
